(19) United States
(12) Patent Application Publication
(10) Pub. No.: US 2005/0271978 A1
(43) Pub. Date: Dec. 8, 2005

(54) Resist polymer, making method, and chemically amplified positive resist composition

(75) Inventors: Takanobu Takeda, Joetsu-shi (JP); Osamu Watanabe, Joetsu-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/142,782

(22) Filed: Jun. 2, 2005

(30) Foreign Application Priority Data
Jun. 3, 2004 (JP) 2004-165553

(51) Int. Cl. G03C 1/492

(52) U.S. Cl. 430/270.1

(57) ABSTRACT

A polymer is prepared by radical polymerization of a monomer using an organotellurium or organoselenium compound as a polymerization initiator. The polymer has a narrower dispersity Mw/Mn and is adequately random. A resist composition comprising the polymer as a base resin has advantages including a dissolution contrast of resist film, high resolution, exposure latitude, process flexibility, good pattern profile after exposure, and minimized line edge roughness.

### CROSS-REFERENCE TO RELATED APPLICATION

This non-provisional application claims priority under 35 U.S.C. §119(a) on Patent Application No. 2004-165553 filed in Japan on Jun. 3, 2004, the entire contents of which are hereby incorporated by reference.

This invention relates to a polymer for resist use, a method for preparing the polymer, and a chemically amplified positive resist composition comprising the polymer as a base resin. More particularly, it relates to a polymer obtained by radical polymerization of a monomer using an organotellurium or organoselenium compound as a polymerization initiator, which polymer is used as a base resin to formulate a chemically amplified positive resist composition which has a significantly high contrast of alkali dissolution rate before and after exposure, a high sensitivity, a high resolution, a good pattern profile and minimized line edge roughness and is thus suitable as micropatterning material in the VLSI fabrication.

### BACKGROUND OF THE INVENTION

While a number of recent efforts are being made to achieve a finer pattern rule in the drive for higher integration and operating speeds in LSI devices, deep-ultraviolet lithography is thought to hold particular promise as the next generation in microfabrication technology. Deep-UV lithography is capable of achieving a minimum feature size of 0.5 μm or less and, when a resist having low light absorption is used, can form patterns with sidewalls that are nearly perpendicular to the substrate.

Recently developed acid-catalyzed chemical amplification positive resists, such as those described in JP-B 2-27660, JP-A 63-27829, U.S. Pat. No. 4,491,628 and U.S. Pat. No. 5,310,619, utilize a high-intensity KrF excimer laser as the deep-UV light source. These resists, with their excellent properties such as high sensitivity, high resolution, and good dry etching resistance, are especially promising for deep-UV lithography.

Such chemically amplified positive resists include two-component systems comprising a base polymer and a photoacid generator, and three-component systems comprising a base polymer, a photoacid generator, and a dissolution inhibitor having acid labile groups.

For example, JP-A 3-275149 and 6-289608 disclose resist materials using a copolymer of hydroxystyrene and (meth)acrylic tertiary ester, intended for the KrF excimer laser exposure. The resist materials of this type suffer from some problems like defects formed after development and an indefinite pattern profile after exposure and are not satisfactory in resolution as well. These problems arise from the methods available for the synthesis of copolymers of hydroxystyrene and (meth)acrylic tertiary ester. One method involves polymerizing an acetoxystyrene monomer with a (meth)acrylic tertiary ester monomer and deblocking acetoxy sites on the resulting polymer. The other method is direct polymerization of a hydroxystyrene monomer with a (meth)acrylic tertiary ester monomer (see JP-A 61-291606). Since these methods are ordinary radical and cationic polymerization methods, there are produced only copolymers having a very broad molecular weight distribution (or dispersity) and lacking randomness. This is also true in resist materials using (meth)acrylate copolymers intended for the ArF excimer laser exposure. Also, living radical polymerization using oxy radicals has been proposed to overcome the drawbacks of the radical polymerization, but this method requires a polymerization temperature as high as 100 to 120° C. and is inadequate for the polymerization into polymers for photoresist use.

Under the current progress toward higher resolution, it would be desirable to have a polymer for resist material use exhibiting good definition of pattern profile after exposure and minimized edge roughness and a method for preparing the same.

### SUMMARY OF THE INVENTION

An object of the invention is to provide a resist composition, typically a chemically amplified positive resist composition, which is superior to prior art positive resist compositions in sensitivity, resolution, exposure latitude and process flexibility, and has a satisfactory pattern profile after exposure and minimized line edge roughness. Another object is to provide a polymer which is useful as a base resin in the resist composition and a method for preparing the polymer.

The inventor has discovered that a polymer is obtained by effecting radical polymerization of a monomer, typically at or below 100° C., using an organotellurium or organoselenium compound as a polymerization initiator and that when this polymer is used as a base resin to formulate a resist composition, typically a positive resist composition, the resulting composition is superior in resist film dissolution contrast, resolution, exposure latitude and process flexibility, and has a satisfactory pattern profile after exposure and minimized line edge roughness, as compared with prior art resist compositions having compounded therein polymers resulting from conventional radical polymerization. The composition is thus suited for practical use and advantageously used in microfabrication, especially in VLSI manufacture.

In one aspect, the invention provides a polymer for resist use, obtained by radical polymerization of a monomer using an organotellurium or organoselenium compound as a polymerization initiator.

In one preferred embodiment, the polymer comprises recurring units having the general formula (1). 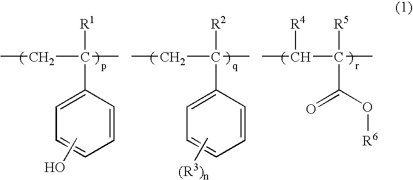
Herein R¹ and R² each are hydrogen or methyl, R³ is a hydrogen atom, straight or branched alkyl group, acid labile group, or halogen atom, R⁴ is hydrogen or methyl, R⁵ is a hydrogen atom, methyl group, trifluoromethyl group, alkoxycarbonyl group, cyano group or halogen atom, R⁶ is a tertiary alkyl group of 4 to 20 carbon atoms, n is 0 or an integer of 1 to 4, p and r are positive numbers, q is 0 or a positive number.

In another preferred embodiment, the polymer comprises recurring units having the general formula (2). 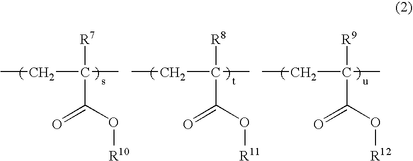
Herein R⁷, R⁸ and R⁹ each are a hydrogen atom, methyl group, trifluoromethyl group, alkoxycarbonyl group, cyano group or halogen atom, R¹⁰ is a tertiary alkyl group of 4 to 30 carbon atoms, R¹¹ is a hydroxyl-containing alkyl group of 2 to 30 carbon atoms, R¹² is a lactone ring-containing alkyl group of 3 to 30 carbon atoms, s is a positive number, t and u each are 0 or a positive number.

The polymer should preferably have a dispersity of up to 1.5.

Typically, the organotellurium or organoselenium compound has the general formula (3) or (4). 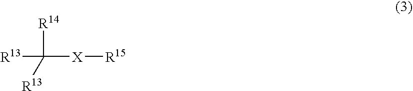
Herein R¹³ is an alkyl group of 1 to 10 carbon atoms, R¹⁴ is a cyano group or alkoxycarbonyl group, R¹⁵ is an alkyl, aryl or alkenyl group of 1 to 30 carbon atoms, and X is Te or Se. 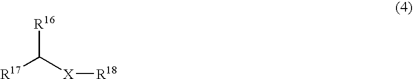
Herein R¹⁶ is hydrogen or methyl, R¹⁷ is an aryl or alkenyl group of 2 to 30 carbon atoms, R¹⁸ is an alkyl, aryl or alkenyl group of 1 to 30 carbon atoms, and X is Te or Se.

In another aspect, the invention provides a method for preparing a polymer for resist use, comprising effecting radical polymerization of a monomer using an organotellurium or organoselenium compound as a polymerization initiator.

In one preferred embodiment, the monomer comprises monomers having the formulae (1a), (1b) and (1c) in amounts of p, q and r moles, respectively, which are subjected to radical polymerization, with the proviso that when R in formula (1a) is a protecting group for hydroxyl, the resulting polymer is deblocked, whereby a polymer comprising recurring units of formula (1) is produced, 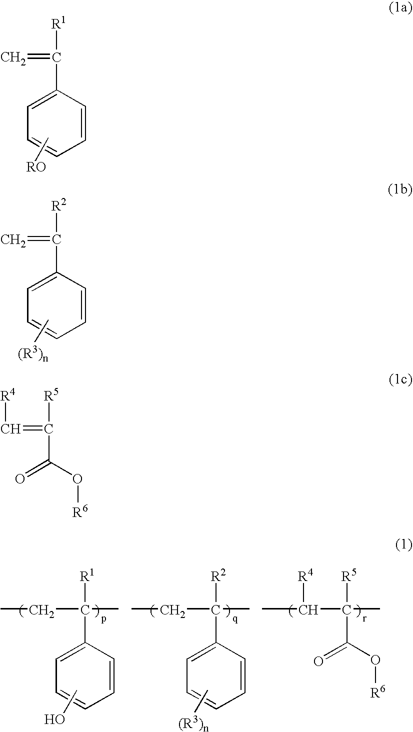
wherein R is hydrogen or a protecting group for hydroxyl, R¹ to R⁶, n, p, q and r are as defined above.

In another preferred embodiment, the monomer comprises monomers having the formulae (2a), (2b) and (2c) in amounts of s, t and u moles, respectively, which are subjected to radical polymerization, whereby a polymer comprising recurring units of formula (2) is produced, 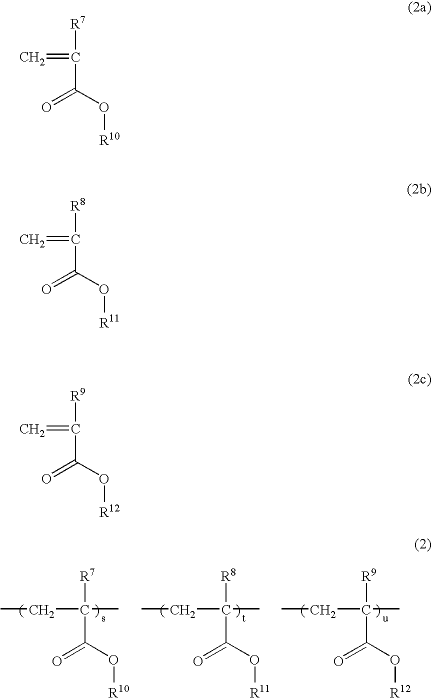
wherein R⁷ to R¹², s, t and u are as defined above.

Typically, the polymer produced by the method has a dispersity of up to 1.5.

Typically, the organotellurium or organoselenium compound has the general formula (3) or (4). 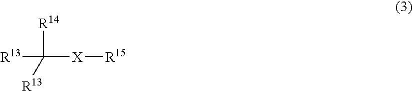
Herein R¹³, R¹⁴, R¹⁵ and X are as defined above. 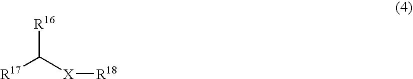
Herein R¹⁶, R¹⁷, R¹⁸ and X are as defined above.

In a further aspect, the invention provides a chemically amplified positive resist composition comprising (A) an organic solvent, (B) the polymer defined above as a base resin, and (C) a photoacid generator. The resist composition may further comprise (D) a dissolution inhibitor and/or (E) a basic compound.

The polymer obtained by radical polymerization of a monomer using an organotellurium or organoselenium compound as a polymerization initiator has a narrower molecular weight distribution or dispersity than polymers obtained by prior art methods. Since copolymerization proceeds in a living fashion, the resulting copolymer is adequately random. When this polymer is compounded as a base resin in a resist composition, the resulting composition is superior in resist film dissolution contrast, resolution, exposure latitude and process flexibility, and has a satisfactory pattern profile after exposure and minimized line edge roughness. The invention thus offers a resist composition, typically a chemically amplified positive resist composition, which is advantageous as a micropatterning material for use in VLSI manufacture.

### DESCRIPTION OF THE PREFERRED EMBODIMENT

Polymer

The polymer of the invention is obtained by polymerization or copolymerization of one or more monomers, typically one or more monomers having a carbon-to-carbon double bond. Radical polymerization is carried out using an organotellurium or organoselenium compound as a polymerization initiator.

The monomers may be selected from a variety of monomers. In one preferred embodiment, the monomer is a mixture of monomers having the formulae (1a), (1b) and (1c) in amounts of p, q and r moles, respectively, which are subjected to radical polymerization, thereby producing a polymer comprising recurring units of formula (1), with the proviso that when R in formula (1a) is a protecting group for hydroxyl, the resulting polymer is deblocked. In another preferred embodiment, the monomer is a mixture of monomers having the formulae (2a), (2b) and (2c) in amounts of s, t and u moles, respectively, which are subjected to radical polymerization, thereby producing a polymer comprising recurring units of formula (2).

These preferred embodiments are described in more detail.
Polymer Comprising Recurring Units of Formula (1) 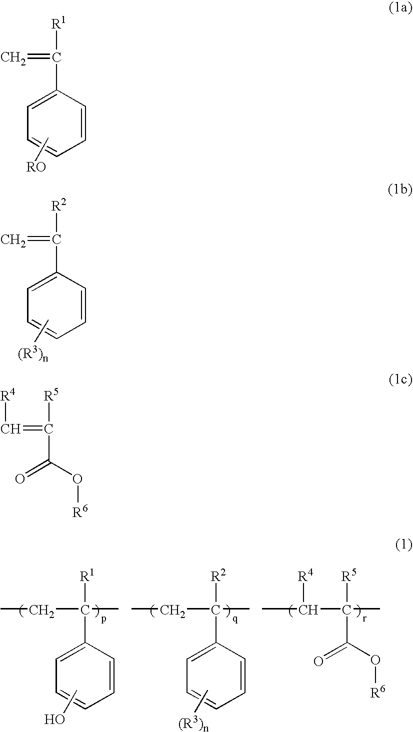
Herein R is hydrogen or a protecting group for hydroxyl. R¹ and R² each are hydrogen or methyl, R³ is a hydrogen atom, straight or branched alkyl group, acid labile group, or halogen atom, R⁴ is hydrogen or methyl, R⁵ is a hydrogen atom, methyl group, trifluoromethyl group, alkoxycarbonyl group, cyano group or halogen atom, and R⁶ is a tertiary alkyl group of 4 to 20 carbon atoms. The letter n is 0 or an integer of 1 to 4, p and r are positive numbers, q is 0 or a positive number.

Examples of the protecting group for hydroxyl represented by R include acetyl, ethoxyethyl, and tert-butyl.

R³ stands for a straight or branched alkyl group, examples of which include methyl, ethyl, propyl, isopropyl, n-butyl, isobutyl and tert-butyl. R³ also stands for an acid labile group, which is selected from a variety of such groups, especially groups of the following formulae (5) and (6), straight, branched or cyclic tertiary alkoxy group of 4 to 20 carbon atoms, trialkylsiloxy groups whose alkyl groups each have 1 to 6 carbon atoms, oxoalkoxy groups of 4 to 20 carbon atoms, tetrahydropyranyloxy, tetrahydrofuranyloxy and trialkylsiloxy groups.

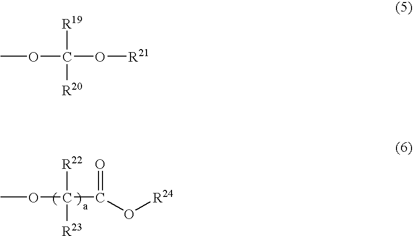

Herein, R¹⁹, R²⁰, R²², and R²³ are independently selected from hydrogen and straight or branched C₁-C₈ alkyl groups. R²¹ is a monovalent hydrocarbon group of 1 to 18 carbon atoms which may be separated by an oxygen atom. A pair of R¹⁹ and R²⁰, a pair of R¹⁹ and R², or a pair of R²⁰ and R²¹ may form a ring with the carbon atom to which they are attached, and each of R¹⁹, R²⁰ and R²¹ is a straight or branched C₁-C₁₈ alkylene group when they form a ring. R²⁴ is a straight, branched or cyclic C₄-C₄₀ alkyl group. The subscript “a” is 0 or a positive integer of 1 to 3.

Illustrative examples of the acid labile group of formula (5) include methoxyethoxy, ethoxyethoxy, n-propoxyethoxy, isopropoxyethoxy, n-butoxyethoxy, isobutoxyethoxy, tert-butoxyethoxy, cyclohexyloxyethoxy, methoxypropoxy, ethoxypropoxy, methoxyisobutoxy, 1-methoxy-1-methyl-ethoxy, and 1-ethoxy-1-methyl-ethoxy. Illustrative examples of the acid labile group of formula (6) include tert-butoxycarbonyloxy, tert-butoxycarbonylmethyloxy, 1-ethylcyclopentylcarbonyloxy, 1-ethylcyclohexylcarbonyloxy, and 1-methylcyclopentylcarbonyloxy. Exemplary of the trialkylsiloxy group are those in which alkyl groups each have 1 to 6 carbon atoms, such as trimethylsiloxy.

R⁵ stands for an alkoxycarbonyl group such as methoxycarbonyl or tert-butoxycarbonyl.

R⁶ stands for a tertiary alkyl group of 4 to 20 carbon atoms which is selected from a variety of such groups, and preferably groups of the following general formulae (7) and (8).

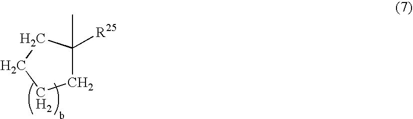

Herein, R²⁵ is a methyl, ethyl, isopropyl, cyclohexyl, cyclopentyl, vinyl, acetyl, phenyl, benzyl or cyano group, and b is an integer of 0 to 3.

The cyclic alkyl groups of formula (7) are preferably 5- and 6-membered rings. Illustrative examples include 1-methylcyclopentyl, 1-ethylcyclopentyl, 1-isopropylcyclopentyl, 1-vinylcyclopentyl, 1-acetylcyclopentyl, 1-phenylcyclopentyl, 1-cyanocyclopentyl, 1-methylcyclohexyl, 1-ethylcyclohexyl, 1-isopropylcyclohexyl, 1-vinylcyclohexyl, 1-acetylcyclohexyl, 1-phenylcyclohexyl, and 1-cyanocyclohexyl.

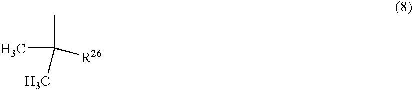

Herein R²⁶ is a methyl, ethyl, isopropyl, cyclohexyl, cyclopentyl, vinyl, phenyl, benzyl or cyano group.

Illustrative examples of the alkyl group of formula (8) include tert-butyl, 1-vinyldimethyl, 1-benzyldimethyl, 1-phenyldimethyl and 1-cyanodimethyl.

It is preferred from the characteristics of resist composition standpoint that in formula (1), p and r are positive numbers and q is 0 or a positive number and satisfy the following equations: 0<r/(p+q+r)≦0.5, more preferably 0.05<r/(p+q+r)≦0.4, 0<p/(p+q+r)≦0.8, more preferably 0.3≦p/(p+q+r)≦0.8, and 0≦q/(p+q+r)≦0.3.

If p or r is equal to 0, that is, if the polymer of formula (1) does not include those units with subscripts p and r, a contrast of alkali dissolution rate is lost, detracting from resolution. If the proportion of p is too high, unexposed areas may have too high an alkali dissolution rate. By properly selecting the value of p, q and r within the above range, the size and profile of a resist pattern can be controlled as desired.
Polymer Comprising Recurring Units of Formula (2) 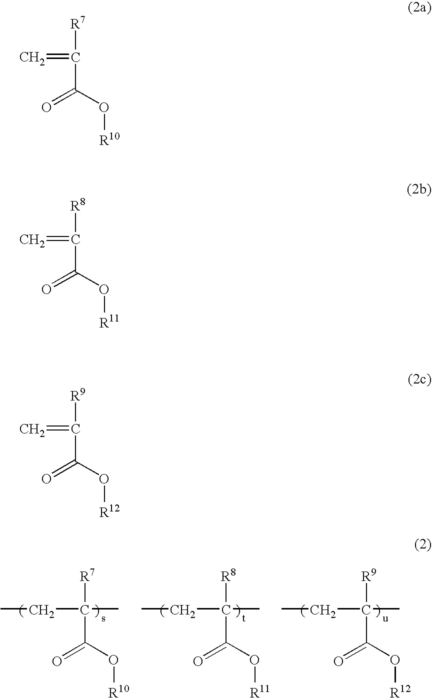
Herein R⁷, R⁸ and R⁹ each are a hydrogen atom, methyl group, trifluoromethyl group, alkoxycarbonyl group, cyano group or halogen atom. R¹⁰ is a tertiary alkyl group of 4 to 30 carbon atoms, R¹¹ is a hydroxyl-containing alkyl group of 2 to 30 carbon atoms, R¹² is a lactone ring-containing alkyl group of 3 to 30 carbon atoms. The letter s is a positive number, t and u each are 0 or a positive number.

R⁷, R⁸ and R⁹ stand for alkoxycarbonyl groups such as methoxycarbonyl and tert-butoxycarbonyl.

R¹⁰ stands for a tertiary alkyl group of 4 to 30 carbon atoms which is selected from a variety of such groups, and preferably groups of the following general formulae (9) and (10).

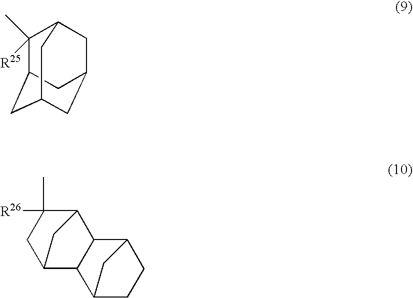

Herein, R²⁵ and R²⁶ each are a methyl, ethyl, isopropyl, cyclohexyl or cyclopentyl group.

The tertiary alkyl groups represented by R¹⁰ also include the tertiary alkyl groups of formulae (7) and (8) described above for R⁶.

R¹¹ stands for hydroxyl-containing alkyl groups of 2 to 30 carbon atoms, examples of which include hydroxymethyl and hydroxyethyl as well as the following.

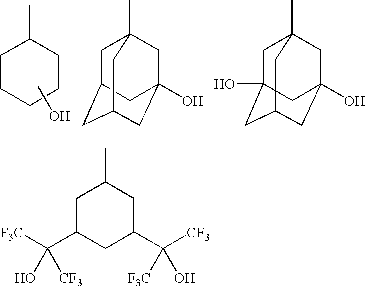

R¹² stands for lactone ring-containing alkyl groups of 3 to 30 carbon atoms, preferred examples of which are given below.

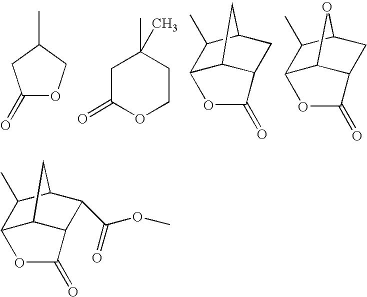

It is preferred from the characteristics of resist composition standpoint that in formula (2), s is a positive number and each of t and u is 0 or a positive number and satisfy the following equations: 0<s/(s+t+u)≦0.8, more preferably 0.05<s/(s+t+u)≦0.6, 0≦t/(s+t+u)≦0.6, more preferably 0.1≦t/(s+t+u)≦0.4, and 0≦u/(s+t+u)≦0.5.

If s is equal to 0, that is, if the polymer of formula (2) does not include those units with subscript s, a contrast of alkali dissolution rate is lost, detracting from resolution. If the proportion of t or u is too low, the polymer will swell substantially during development by alkali dissolution, resulting in such problems as a degraded pattern profile and the generation of scum following development. By properly selecting the value of s, t and u within the above range, the size and profile of a resist pattern can be controlled as desired.

The polymers of the invention are prepared by radical polymerization of one or more monomers using an organotellurium or organoselenium compound as a polymerization initiator. It is preferred that the organotellurium or organoselenium compound used herein have the general formula (3) or (4). 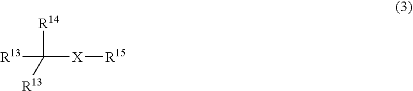
Herein R¹³ is an alkyl group of 1 to 10 carbon atoms, R¹⁴ is a cyano group or alkoxycarbonyl group, R¹⁵ is an alkyl, aryl or alkenyl group of 1 to 30 carbon atoms, and X is tellurium (Te) or selenium (Se).

R¹³ stands for an alkyl group which is selected from a variety of such groups, for example, methyl, ethyl and isobutyl. The alkyl group represented by R¹³ may have a cyclic structure, and exemplary such groups are cyclohexyl and cyclopentyl. Examples of the alkyl, aryl or alkenyl group represented by R¹⁵ include methyl, ethyl, butyl, phenyl, vinyl and allyl.

Typical examples of the compound having formula (3) are given below. 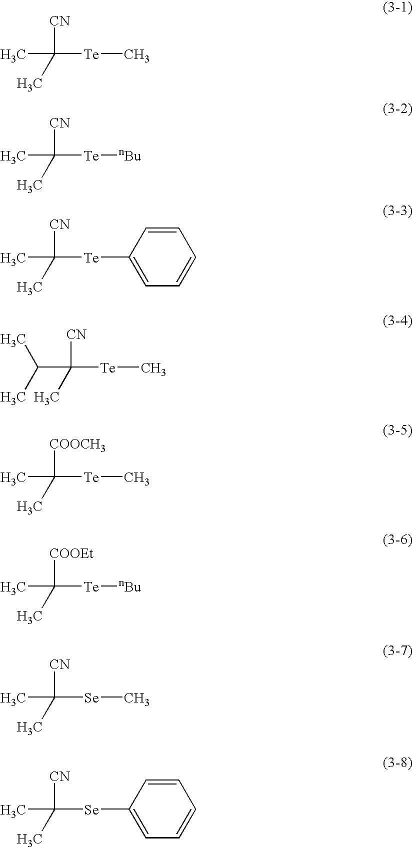
Note that Et is ethyl and ⁿBu is n-butyl.

The compound having formula (3) can be synthesized from a dialkylditelluride or dialkyldiselenide and a corresponding azo compound which is generally used as a polymerization initiator. A polymer can be synthesized by several procedures, for example, by adding a dialkylditelluride or dialkyldiselenide and a starting polymerization initiator (azo compound) directly to a reaction solution of monomers, or by post-adding monomers to a reaction solution in which the compound of formula (3) has been synthesized. Exemplary of the azo compound are 2,2′-azobisisobutyronitrile and dimethyl-2,2′-azobis(2-methylpropionate). 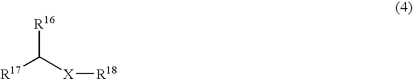
Herein R¹⁶ is hydrogen or methyl, R¹⁷ is an aryl or alkenyl group of 2 to 30 carbon atoms, R¹⁸ is an alkyl, aryl or alkenyl group of 1 to 30 carbon atoms, and X is Te or Se.

Examples of the aryl and alkenyl groups represented by R¹⁷ include phenyl, vinyl and allyl. Examples of the alkyl, aryl and alkenyl groups represented by R¹⁸ include methyl, butyl, phenyl and allyl. The compound of formula (4) can be synthesized by coupling reaction between Grignard reagents such as R¹⁸XLi and R¹⁸XMgCl and halogen reagents such as R¹⁷(R¹⁶)CH₂Br.

The polymers of formulae (1) and (2) should preferably have a weight average molecular weight (Mw) of about 1,000 to 500,000 and preferably about 2,000 to 30,000, as determined by gel permeation chromatography (GPC) relative to polystyrene standards. With too low Mw, polymers become less resistant to heat. Polymers with too high Mw have low alkali solubility and tend to induce a footing phenomenon after pattern formation.

It is recommended that the multi-component copolymers of formulae (1) and (2) have a controlled molecular weight distribution or dispersity (Mw/Mn). If a copolymer has a wide dispersity, it contains more polymer fractions of low molecular weight and high molecular weight and thus forms a pattern after exposure with foreign matter left thereon or its profile collapsed. The influence of a molecular weight and its dispersity becomes greater as the pattern rule becomes finer. In order that a resist composition be advantageously used in patterning features to a finer size, the multi-component copolymer should preferably be a narrow disperse one having a dispersity of 1.0 to 1.7, especially 1.0 to 1.5.

Several procedures are feasible in synthesizing the polymers. In one procedure, one or more monomers are dissolved in an organic solvent, a radical initiator which is an organotellurium or organoselenium compound of formula (3) or (4) is added thereto, and heat polymerization is carried out to form a polymer. If necessary, the polymer is subjected to alkaline hydrolysis in the organic solvent for deblocking the protecting groups, thereby obtaining a polymer in the form of a multi-component copolymer. The organic solvent used during the polymerization is toluene, benzene, tetrahydrofuran, diethyl ether or dioxane, to name a few. Equivalent polymerization is possible when an azo compound and a dialkylditelluride or dialkyldiselenide are copresent in the reaction system as the polymerization initiator. Polymerization may be effected by heating at a temperature of about 40° C. to 120° C., preferably 50 to 100° C. At temperatures above 110° C., a tertiary (meth)acrylate to be copolymerized can be decomposed. The reaction time is usually about 2 to 100 hours, preferably about 5 to 20 hours.

Alternatively, polymerization may be effected by adding dropwise monomers to a heated reaction system at any time over the course of reaction. Additionally, the radical initiator of formula (3) or (4) may also be added dropwise.

Alkaline hydrolysis is carried out when the acetoxy protecting group is to be deblocked. To this end, bases such as aqueous ammonia and triethylamine may be used. The reaction temperature is in a range of about −20° C. to 100° C., preferably about 0° C. to 60° C. The reaction time is in a range of about 0.2 to 100 hours, preferably about 0.5 to 20 hours.

After the polymer thus obtained is isolated, acid labile groups can be introduced into phenolic hydroxyl moieties. For example, phenolic hydroxyl groups on the polymer can be reacted with an alkenyl ether compound in the presence of an acid catalyst, producing a polymer in which some phenolic hydroxyl groups are blocked or protected with alkoxyalkyl groups.

The reaction solvent used herein is preferably an aprotic polar solvent such as dimethylformamide, dimethylacetamide, tetrahydrofuran or ethyl acetate, which may be used alone or in admixture of any. The acid catalyst is preferably selected from among hydrochloric acid, sulfuric acid, trifluoromethanesulfonic acid, p-toluenesulfonic acid, methanesulfonic acid, and pyridinium p-toluenesulfonate. The amount of the alkenyl ether compound used is 0.1 to 10 mol % per mol of phenolic hydroxyl groups on the polymer. The reaction temperature is about −20° C. to 100° C., preferably about 0° C. to 60° C.; and the reaction time is usually about 0.2 to 100 hours, preferably about 0.5 to 20 hours.

In another embodiment, a halogenated alkyl ether compound can be used. It is reacted with the polymer in the presence of a base to produce a polymer in which phenolic hydroxyl groups are partially protected or blocked with alkoxyalkyl groups.

In this embodiment, the reaction solvent used is preferably selected from aprotic polar solvents such as acetonitrile, acetone, dimethylformamide, dimethylacetamide, tetrahydrofuran, and dimethyl sulfoxide. Such solvents may be used alone or in admixture of any. Preferred bases include triethylamine, pyridine, diisopropylamine and potassium carbonate. The amount of the reactant used is preferably at least 10 mol % per mol of phenolic hydroxyl groups on the polymer. The reaction temperature is often in the range of about −50° C. to 100° C., and preferably about 0° C. to 60° C. The reaction time is from about 0.5 to 100 hours, and preferably about 1 to 20 hours.

In a further embodiment, the tertiary alkoxycarbonyl group can be introduced by reacting a dialkyl dicarbonate compound or alkoxycarbonylalkyl halide with the polymer in a solvent in the presence of a base. The reaction solvent used is preferably selected from aprotic polar solvents such as acetonitrile, acetone, dimethylformamide, dimethylacetamide, tetrahydrofuran, and dimethyl sulfoxide. Such solvents may be used alone or in admixture of any. Preferred bases include triethylamine, pyridine, imidazole, diisopropylamine and potassium carbonate. The amount of the reactant used is preferably at least 10 mol % per mol of phenolic hydroxyl groups on the starting polymer. The reaction temperature is often in the range of about 0° C. to 100° C., and preferably about 0° C. to 60° C. The reaction time is from about 0.2 to 100 hours, and preferably about 1 to 10 hours.

Exemplary of the dialkyl dicarbonate compound are di-tert-butyl dicarbonate and di-tert-amyl dicarbonate. Examples of the alkoxycarbonylalkyl halide include tert-butoxycarbonylmethyl chloride, tert-amyloxycarbonylmethyl chloride, tert-butoxycarbonylmethyl bromide and tert-butoxycarbonylethyl chloride.

The invention is not limited to these synthesis procedures.

Resist Composition

The polymers of the invention are used as a base resin in resist compositions, typically positive resist compositions, and especially, chemically amplified positive resist compositions. Specifically the chemically amplified positive resist composition comprises (A) an organic solvent, (B) the inventive polymer as a base resin, (C) a photoacid generator, and optionally, (D) a dissolution inhibitor and/or (E) a basic compound.

In the chemically amplified, positive working resist composition of the invention, component (A) is an organic solvent. Illustrative, non-limiting examples of the solvent include ketones such as cyclohexanone and methyl-2-n-amylketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate; and lactones such as γ-butyrolactone. These solvents may be used alone or in combinations of two or more thereof. Of the above organic solvents, it is recommended to use diethylene glycol dimethyl ether, 1-ethoxy-2-propanol, propylene glycol monomethyl ether acetate, or a mixture thereof because the acid generator is most soluble therein.

An appropriate amount of the organic solvent used is about 200 to 1,000 parts, especially about 400 to 800 parts by weight per 100 parts by weight of the base resin.

The photoacid generator (C) is a compound capable of generating an acid upon exposure to high energy radiation. Preferred photoacid generators are sulfonium salts, iodonium salts, sulfonyldiazomethanes, and N-sulfonyloxyimides. These photoacid generators are illustrated below while they may be used alone or in admixture of two or more.

Sulfonium salts are salts of sulfonium cations with sulfonates. Exemplary sulfonium cations include triphenylsulfonium, (4-tert-butoxyphenyl)diphenylsulfonium, bis(4-tert-butoxyphenyl)phenylsulfonium, tris(4-tert-butoxyphenyl)sulfonium, (3-tert-butoxyphenyl)diphenylsulfonium, bis(3-tert-butoxyphenyl)phenylsulfonium, tris(3-tert-butoxyphenyl)sulfonium, (3,4-di-tert-butoxyphenyl)diphenylsulfonium, bis(3,4-di-tert-butoxyphenyl)phenylsulfonium, tris(3,4-di-tert-butoxyphenyl)sulfonium, diphenyl(4-thiophenoxyphenyl)sulfonium, (4-tert-butoxycarbonylmethyloxyphenyl)diphenylsulfonium, tris(4-tert-butoxycarbonylmethyloxyphenyl)sulfonium, (4-tert-butoxyphenyl)bis(4-dimethylaminophenyl)sulfonium, tris(4-dimethylaminophenyl)sulfonium, 2-naphthyldiphenylsulfonium, dimethyl-2-naphthylsulfonium, 4-hydroxyphenyldimethylsulfonium, 4-methoxyphenyldimethylsulfonium, trimethylsulfonium, 2-oxocyclohexylcyclohexylmethylsulfonium, trinaphthylsulfonium, tribenzylsulfonium, diphenylmethylsulfonium, dimethylphenylsulfonium, and 2-oxo-2-phenylethylthiacyclopentanium. Exemplary sulfonates include trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4′-toluenesulfonyloxy)benzenesulfonate, naphthalenesulfonate, camphorsulfonate, octanesulfonate, dodecylbenzenesulfonate, butanesulfonate, and methanesulfonate. Sulfonium salts based on combination of the foregoing examples are included.

Iodinium salts are salts of iodonium cations with sulfonates. Exemplary iodinium cations are aryliodonium cations including diphenyliodinium, bis(4-tert-butylphenyl)iodonium, 4-tert-butoxyphenylphenyliodonium, and 4-methoxyphenylphenyliodonium. Exemplary sulfonates include trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, 4-(4-toluenesulfonyloxy)benzenesulfonate, naphthalenesulfonate, camphorsulfonate, octanesulfonate, dodecylbenzenesulfonate, butanesulfonate, and methanesulfonate. Iodonium salts based on combination of the foregoing examples are included.

Exemplary sulfonyldiazomethane compounds include bissulfonyldiazomethane compounds and sulfonyl-carbonyldiazomethane compounds such as bis(ethylsulfonyl)diazomethane, bis(1-methylpropylsulfonyl)diazomethane, bis(2-methylpropylsulfonyl)diazomethane, bis(1,1-dimethylethylsulfonyl)diazomethane, bis(cyclohexylsulfonyl)diazomethane, bis(perfluoroisopropylsulfonyl)diazomethane, bis(phenylsulfonyl)diazomethane, bis(4-methylphenylsulfonyl)diazomethane, bis(2,4-dimethylphenylsulfonyl)diazomethane, bis(2-naphthylsulfonyl)diazomethane, bis(4-acetyloxyphenylsolfonyl)diazomethane, bis(4-methanesulfonyloxyphenylsulfonyl)diazomethane, bis(4-(4-toluenesulfonyloxy)phenylsulfonyl)diazomethane, bis(4-n-hexyloxy)phenylsulfonyl)diazomethane, bis(2-methyl-4-(n-hexyloxy)phenylsulfonyl)diazomethane, bis(2,5-dimethyl-4-(n-hexyloxy)phenylsulfonyl)diazomethane, bis(3,5-dimethyl-4-(n-hexyloxy)phenylsulfonyl)diazomethane, bis(2-methyl-5-isopropyl-4-(n-hexyloxy)phenylsulfonyl)-diazomethane, 4-methylphenylsulfonylbenzoyldiazomethane, tert-butylcarbonyl-4-methylphenylsulfonyldiazomethane, 2-naphthylsulfonylbenzoyldiazomethane, 4-methylphenylsulfonyl-2-naphthoyldiazomethane, methylsulfonylbenzoyldiazomethane, and tert-butoxycarbonyl-4-methylphenylsulfonyldiazomethane.

N-sulfonyloxyimide photoacid generators include combinations of imide skeletons with sulfonates. Exemplary imide skeletons are succinimide, naphthalene dicarboxylic acid imide, phthalimide, cyclohexyldicarboxylic acid imide, 5-norbornene-2,3-dicarboxylic acid imide, and 7-oxabicyclo[2.2.1]-5-heptene-2,3-dicarboxylic acid imide. Exemplary sulfonates include trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, mesitylenesulfonate, 2,4,6-triisopropylbenzenesulfonate, toluenesulfonate, benzenesulfonate, naphthalenesulfonate, camphorsulfonate, octanesulfonate, dodecylbenzenesulfonate, butanesulfonate, and methanesulfonate.

Benzoinsulfonate photoacid generators include benzoin tosylate, benzoin mesylate, and benzoin butanesulfonate.

Pyrogallol trisulfonate photoacid generators include pyrogallol, fluoroglycine, catechol, resorcinol, and hydroquinone, in which all the hydroxyl groups are replaced by trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, and methanesulfonate.

Nitrobenzyl sulfonate photoacid generators include 2,4-dinitrobenzyl sulfonate, 2-nitrobenzyl sulfonate, and 2,6-dinitrobenzyl sulfonate, with exemplary sulfonates including trifluoromethanesulfonate, nonafluorobutanesulfonate, heptadecafluorooctanesulfonate, 2,2,2-trifluoroethanesulfonate, pentafluorobenzenesulfonate, 4-trifluoromethylbenzenesulfonate, 4-fluorobenzenesulfonate, toluenesulfonate, benzenesulfonate, naphthalenesulfonate, camphorsulfonate, octanesulfonate, dodecylbenzenesulfonate, butanesulfonate, and methanesulfonate. Also useful are analogous nitrobenzyl sulfonate compounds in which the nitro group on the benzyl side is replaced by a trifluoromethyl group.

Sulfone photoacid generators include bis(phenylsulfonyl)methane, bis(4-methylphenylsulfonyl)methane, bis(2-naphthylsulfonyl)methane, 2,2-bis(phenylsulfonyl)propane, 2,2-bis(4-methylphenylsulfonyl)propane, 2,2-bis(2-naphthylsulfonyl)propane, 2-methyl-2-(p-toluenesulfonyl)propiophenone, 2-cyclohexylcarbonyl-2-(p-toluenesulfonyl)propane, and 2,4-dimethyl-2-(p-toluenesulfonyl)pentan-3-one.

Photoacid generators in the form of glyoxime derivatives are as described in Japanese Patent No. 2,906,999 and JP-A 9-301948. Examples include bis-O-(p-toluenesulfonyl)-α-dimethylglyoxime, bis-O-(p-toluenesulfonyl)-α-diphenylglyoxime, bis-O-(p-toluenesulfonyl)-α-dicyclohexylglyoxime, bis-O-(p-toluenesulfonyl)-2,3-pentanedioneglyoxime, bis-O-(n-butanesulfonyl)-α-dimethylglyoxime, bis-O-(n-butanesulfonyl)-α-diphenylglyoxime, bis-O-(n-butanesulfonyl)-α-dicyclohexylglyoxime, bis-O-(methanesulfonyl)-α-dimethylglyoxime, bis-O-(trifluoromethanesulfonyl)-α-dimethylglyoxime, bis-O-(2,2,2-trifluoroethanesulfonyl)-α-dimethylglyoxime, bis-O-(10-camphorsulfonyl)-α-dimethylglyoxime, bis-O-(benzenesulfonyl)-α-dimethylglyoxime, bis-O-(p-fluorobenzenesulfonyl)-α-dimethylglyoxime, bis-O-(p-trifluoromethylbenzenesulfonyl)-α-dimethylglyoxime, bis-O-(xylenesulfonyl)-α-dimethylglyoxime, bis-O-(trifluoromethanesulfonyl)-nioxime, bis-O-(2,2,2-trifluoroethanesulfonyl)-nioxime, bis-O-(10-camphorsulfonyl)-nioxime, bis-O-(benzenesulfonyl)-nioxime, bis-O-(p-fluorobenzenesulfonyl)-nioxime, bis-O-(p-trifluoromethylbenzenesulfonyl)-nioxime, and bis-O-(xylenesulfonyl)-nioxime.

Also included are the oxime sulfonates described in U.S. Pat. No. 6,004,724, for example, (5-(4-toluenesulfonyl)oxyimino-5H-thiophen-2-ylidene)-phenylacetonitrile, (5-(10-camphorsulfonyl)oxyimino-5H-thiophen-2-ylidene)-phenylacetonitrile, (5-n-octanesulfonyloxyimino-5H-thiophen-2-ylidene)-phenylacetonitrile, (5-(4-toluenesulfonyl)oxyimino-5H-thiophen-2-ylidene)(2-methylphenyl)acetonitrile, (5-(10-camphorsulfonyl)oxyimino-5H-thiophen-2-ylidene)(2-methylphenyl)acetonitrile, (5-n-octanesulfonyloxyimino-5H-thiophen-2-ylidene)(2-methylphenyl)acetonitrile, etc.

Also included are the oxime sulfonates described in U.S. Pat. No. 6,261,738 and JP-A 2000-314956, for example, 2,2,2-trifluoro-1-phenyl-ethanone oxime-O-methylsulfonate; 2,2,2-trifluoro-1-phenyl-ethanone oxime-O-(10-camphorylsulfonate); 2,2,2-trifluoro-1-phenyl-ethanone oxime-O-(4-methoxyphenylsulfonate); 2,2,2-trifluoro-1-phenyl-ethanone oxime-O-(1-naphthylsulfonate); 2,2,2-trifluoro-1-phenyl-ethanone oxime-O-(2-naphthylsulfonate); 2,2,2-trifluoro-1-phenyl-ethanone oxime-O-(2,4,6-trimethylphenylsulfonate); 2,2,2-trifluoro-1-(4-methylphenyl)-ethanone oxime-O-(10-camphorylsulfonate); 2,2,2-trifluoro-1-(4-methylphenyl)-ethanone oxime-O-(methylsulfonate); 2,2,2-trifluoro-1-(2-methylphenyl)-ethanone oxime-O-(10-camphorylsulfonate); 2,2,2-trifluoro-1-(2,4-dimethylphenyl)-ethanone oxime-O-(10-camphorylsulfonate); 2,2,2-trifluoro-1-(2,4-dimethylphenyl)-ethanone oxime-O-(1-naphthylsulfonate); 2,2,2-trifluoro-1-(2,4-dimethylphenyl)-ethanone oxime-O-(2-naphthylsulfonate); 2,2,2-trifluoro-1-(2,4,6-trimethylphenyl)-ethanone oxime-O-(10-camphorylsulfonate); 2,2,2-trifluoro-1-(2,4,6-trimethylphenyl)-ethanone oxime-O-(1-naphthylsulfonate); 2,2,2-trifluoro-1-(2,4,6-trimethylphenyl)-ethanone oxime-O-(2-naphthylsulfonate); 2,2,2-trifluoro-1-(4-methoxyphenyl)-ethanone oxime-O-methylsulfonate; 2,2,2-trifluoro-1-(4-methylthiophenyl)-ethanone oxime-O-methylsulfonate; 2,2,2-trifluoro-1-(3,4-dimethoxyphenyl)-ethanone oxime-O-methylsulfonate; 2,2,3,3,4,4,4-heptafluoro-1-phenyl-butanone oxime-O-(10-camphorylsulfonate); 2,2,2-trifluoro-1-(phenyl)-ethanone oxime-O-methylsulfonate; 2,2,2-trifluoro-1-(phenyl)-ethanone oxime-O-10-camphorylsulfonate; 2,2,2-trifluoro-1-(phenyl)-ethanone oxime-O-(4-methoxyphenyl)sulfonate; 2,2,2-trifluoro-1-(phenyl)-ethanone oxime-O-(1-naphthyl)-sulfonate; 2,2,2-trifluoro-1-(phenyl)-ethanone oxime-O-(2-naphthyl)sulfonate; 2,2,2-trifluoro-1-(phenyl)-ethanone oxime-O-(2,4,6-trimethylphenyl)sulfonate; 2,2,2-trifluoro-1-(4-methylphenyl)-ethanone oxime-O-(10-camphoryl)sulfonate; 2,2,2-trifluoro-1-(4-methylphenyl)-ethanone oxime-O-methylsulfonate; 2,2,2-trifluoro-1-(2-methylphenyl)-ethanone oxime-O-(10-camphoryl)sulfonate; 2,2,2-trifluoro-1-(2,4-dimethylphenyl)-ethanone oxime-O-(1-naphthyl)sulfonate; 2,2,2-trifluoro-1-(2,4-dimethylphenyl)-ethanone oxime-O-(2-naphthyl)sulfonate; 2,2,2-trifluoro-1-(2,4,6-trimethylphenyl)-ethanone oxime-O-(10-camphoryl)sulfonate; 2,2,2-trifluoro-1-(2,4,6-trimethylphenyl)-ethanone oxime-O-(1-naphthyl)sulfonate; 2,2,2-trifluoro-1-(2,4,6-trimethylphenyl)-ethanone oxime-O-(2-naphthyl)sulfonate; 2,2,2-trifluoro-1-(4-methoxyphenyl)-ethanone oxime-O-methylsulfonate; 2,2,2-trifluoro-1-(4-thiomethylphenyl)-ethanone oxime-O-methylsulfonate; 2,2,2-trifluoro-1-(3,4-dimethoxyphenyl)-ethanone oxime-O-methylsulfonate; 2,2,2-trifluoro-1-(4-methoxyphenyl)-ethanone oxime-O-(4-methylphenyl)sulfonate; 2,2,2-trifluoro-1-(4-methoxyphenyl)-ethanone oxime-O-(4-methoxyphenyl)sulfonate; 2,2,2-trifluoro-1-(4-methoxyphenyl)-ethanone oxime-O-(4-dodecylphenyl)-sulfonate; 2,2,2-trifluoro-1-(4-methoxyphenyl)-ethanone oxime-O-octylsulfonate; 2,2,2-trifluoro-1-(4-thiomethylphenyl)-ethanone oxime-O-(4-methoxyphenyl)sulfonate; 2,2,2-trifluoro-1-(4-thiomethylphenyl)-ethanone oxime-O-(4-dodecylphenyl)sulfonate; 2,2,2-trifluoro-1-(4-thiomethyl-phenyl)-ethanone oxime-O-octylsulfonate; 2,2,2-trifluoro-1-(4-thiomethylphenyl)-ethanone oxime-O-(2-naphthyl)sulfonate; 2,2,2-trifluoro-1-(2-methylphenyl)-ethanone oxime-O-methylsulfonate; 2,2,2-trifluoro-1-(4-methylphenyl)ethanone oxime-O-phenylsulfonate; 2,2,2-trifluoro-1-(4-chlorophenyl)-ethanone oxime-O-phenylsulfonate; 2,2,3,3,4,4,4-heptafluoro-1-(phenyl)-butanone oxime-O-(10-camphoryl)sulfonate; 2,2,2-trifluoro-1-naphthyl-ethanone oxime-O-methylsulfonate; 2,2,2-trifluoro-2-naphthyl-ethanone oxime-O-methylsulfonate; 2,2,2-trifluoro-1-[4-benzylphenyl]-ethanone oxime-O-methylsulfonate; 2,2,2-trifluoro-1-[4-(phenyl-1,4-dioxa-but-1-yl)phenyl]-ethanone oxime-O-methylsulfonate; 2,2,2-trifluoro-1-naphthyl-ethanone oxime-O-propylsulfonate; 2,2,2-trifluoro-2-naphthyl-ethanone oxime-O-propylsulfonate; 2,2,2-trifluoro-1-[4-benzylphenyl]-ethanone oxime-O-propylsulfonate; 2,2,2-trifluoro-1-[4-methylsulfonylphenyl]-ethanone oxime-O-propylsulfonate; 1,3-bis[1-(4-phenoxyphenyl)-2,2,2-trifluoroethanone oxime-O-sulfonyl]phenyl; 2,2,2-trifluoro-1-[4-methylsulfonyloxyphenyl]-ethanone oxime-O-propylsulfonate; 2,2,2-trifluoro-1-[4-methylcarbonyloxyphenyl]-ethanone oxime-O-propylsulfonate; 2,2,2-trifluoro-1-[6H,7H-5,8-dioxonaphth-2-yl]-ethanone oxime-O-propylsulfonate; 2,2,2-trifluoro-1-[4-methoxycarbonylmethoxyphenyl]-ethanone oxime-O-propylsulfonate; 2,2,2-trifluoro-1-[4-(methoxycarbonyl)-(4-amino-1-oxa-pent-1-yl)-phenyl]-ethanone oxime-O-propylsulfonate; 2,2,2-trifluoro-1-[3,5-dimethyl-4-ethoxyphenyl]-ethanone oxime-O-propylsulfonate; 2,2,2-trifluoro-1-[4-benzyloxyphenyl]-ethanone oxime-O-propylsulfonate; 2,2,2-trifluoro-1-[2-thiophenyl]-ethanone oxime-O-propylsulfonate; and 2,2,2-trifluoro-1-[1-dioxa-thiophen-2-yl)]-ethanone oxime-O-propylsulfonate.

Also included are the oxime sulfonates described in JP-A 9-95479 and JP-A 9-230588 and the references cited therein, for example, α-(p-toluenesulfonyloxyimino)-phenylacetonitrile, α-(p-chlorobenzenesulfonyloxyimino)-phenylacetonitrile, α-(4-nitrobenzenesulfonyloxyimino)-phenylacetonitrile, α-(4-nitro-2-trifluoromethylbenzenesulfonyloxyimino)-phenylacetonitrile, α-(benzenesulfonyloxyimino)-4-chlorophenylacetonitrile, α-(benzenesulfonyloxyimino)-2,4-dichlorophenylacetonitrile, α-(benzenesulfonyloxyimino)-2,6-dichlorophenylacetonitrile, α-(benzenesulfonyloxyimino)-4-methoxyphenylacetonitrile, α-(2-chlorobenzenesulfonyloxyimino)-4-methoxyphenylacetonitrile, α-(benzenesulfonyloxyimino)-2-thienylacetonitrile, α-(4-dodecylbenzenesulfonyloxyimino)-phenylacetonitrile, α-[(4-toluenesulfonyloxyimino)-4-methoxyphenyl]acetonitrile, α-[(dodecylbenzenesulfonyloxyimino)-4-methoxyphenyl]-acetonitrile, α-(tosyloxyimino)-3-thienylacetonitrile, α-(methylsulfonyloxyimino)-1-cyclopentenylacetonitrile, α-(ethylsulfonyloxyimino)-1-cyclopentenylacetonitrile, α-(isopropylsulfonyloxyimino)-1-cyclopentenylacetonitrile, α-(n-butylsulfonyloxyimino)-1-cyclopentenylacetonitrile, α-(ethylsulfonyloxyimino)-1-cyclohexenylacetonitrile, α-(isopropylsulfonyloxyimino)-1-cyclohexenylacetonitrile, and α-(n-butylsulfonyloxyimino)-1-cyclohexenylacetonitrile.

Suitable bisoxime sulfonates include those described in JP-A 9-208554, for example, bis(α-(4-toluenesulfonyloxy)imino)-p-phenylenediacetonitrile, bis(α-(benzenesulfonyloxy)imino)-p-phenylenediacetonitrile, bis(α-(methanesulfonyloxy)imino)-p-phenylenediacetonitrile, bis(α-(butanesulfonyloxy)imino)-p-phenylenediacetonitrile, bis(α-(10-camphorsulfonyloxy)imino)-p-phenylenediacetonitrile, bis(α-(4-toluenesulfonyloxy)imino)-p-phenylenediacetonitrile, bis(α-(trifluoromethanesulfonyloxy)imino)-p-phenylenediacetonitrile, bis(α-(4-methoxybenzenesulfonyloxy)imino)-p-phenylenediacetonitrile, bis(α-(4-toluenesulfonyloxy)imino)-m-phenylenediacetonitrile, bis(α-(benzenesulfonyloxy)imino)-m-phenylenediacetonitrile, bis(α-(methanesulfonyloxy)imino)-m-phenylenediacetonitrile, bis(α-(butanesulfonyloxy)imino)-m-phenylenediacetonitrile, bis(α-(10-camphorsulfonyloxy)imino)-m-phenylenediacetonitrile, bis(α-(4-toluenesulfonyloxy)imino)-m-phenylenediacetonitrile, bis(α-(trifluoromethanesulfonyloxy)imino)-m-phenylenediacetonitrile, bis(α-(4-methoxybenzenesulfonyloxy)imino)-m-phenylenediacetonitrile, etc.

Of the photoacid generators, sulfonium salts, bissulfonyldiazomethanes, N-sulfonyloxyimides and glyoxime derivatives are preferred, with the sulfonium salts, bissulfonyldiazomethanes, and N-sulfonyloxyimides being most preferred. Illustrative examples include triphenylsulfonium p-toluenesulfonate, triphenylsulfonium camphorsulfonate, triphenylsulfonium pentafluorobenzenesulfonate, triphenylsulfonium nonafluorobutanesulfonate, triphenylsulfonium 4-(4′-toluenesulfonyloxy)benzenesulfonate, triphenylsulfonium 2,4,6-triisopropylbenzenesulfonate, 4-tert-butoxyphenyldiphenylsulfonium p-toluenesulfonate, 4-tert-butoxyphenyldiphenylsulfonium camphorsulfonate, 4-tert-butoxyphenyldiphenylsulfonium 4-(4′-toluenesulfonyloxy)benzenesulfonate, tris(4-methylphenyl)sulfonium camphorsulfonate, tris(4-tert-butylphenyl)sulfonium camphorsulfonate, bis(tert-butylsulfonyl)diazomethane, bis(cyclohexylsulfonyl)diazomethane, bis(2,4-dimethylphenylsulfonyl)diazomethane, bis(4-(n-hexyloxy)phenylsulfonyl)diazomethane, bis(2-methyl-4-(n-hexyloxy)phenylsulfonyl)diazomethane, bis(2,5-dimethyl-4-(n-hexyloxy)phenylsulfonyl)diazomethane, bis(3,5-dimethyl-4-(n-hexyloxy)phenylsulfonyl)diazomethane, bis(2-methyl-5-isopropyl-4-(n-hexyloxy)phenylsulfonyl)-diazomethane, bis(4-tert-butylphenylsulfonyl)diazomethane, N-camphorsulfonyloxy-5-norbornene-2,3-dicarboxylic acid imide, and N-p-toluenesulfonyloxy-5-norbornene-2,3-dicarboxylic acid imide.

The photoacid generators may be used alone or in admixture. It is also possible to use a photoacid generator having a low transmittance at the exposure wavelength in a controlled amount so as to adjust the transmittance of a resist coating.

In the chemically amplified positive resist composition of the invention, the photoacid generator may be added in any desired amount, typically 0.1 to 10 parts, and preferably 0.2 to 5 parts by weight, per 100 parts by weight of the base resin in the composition. Excessive amounts of the photoacid generator may degrade resolution and give rise to a problem of foreign matter during development and resist peeling.

The dissolution inhibitor (D) is a compound having on the molecule at least two phenolic hydroxyl groups, in which an average of from 10 to 100 mol % of all the hydrogen atoms on the phenolic hydroxyl groups are replaced with acid labile groups. The compound has a weight average molecular weight within the range of 100 to 1,000, and preferably 150 to 800.

The dissolution inhibitor may be formulated in an amount of 0 to 50 parts, preferably 5 to 50 parts, and more preferably 10 to 30 parts by weight, per 100 parts by weight of the base resin, and may be used singly or as a mixture of two or more thereof. Less amounts of the dissolution inhibitor may fail to yield an improved resolution, whereas too much amounts would lead to slimming of the patterned film, and thus a decline in resolution.

Illustrative, non-limiting, examples of the dissolution inhibitor (D) which are useful herein include bis(4-(2′-tetrahydropyranyloxy)phenyl)methane, bis(4-(2′-tetrahydrofuranyloxy)phenyl)methane, bis(4-tert-butoxyphenyl)methane, bis(4-tert-butoxycarbonyloxyphenyl)methane, bis(4-tert-butoxycarbonylmethyloxyphenyl)methane, bis(4-(1′-ethoxyethoxy)phenyl)methane, bis(4-(1′-ethoxypropyloxy)phenyl)methane, 2,2-bis(4′-(2″-tetrahydropyranyloxy))propane, 2,2-bis(4′-(2″-tetrahydrofuranyloxy)phenyl)propane, 2,2-bis(4′-tert-butoxyphenyl)propane, 2,2-bis(4′-tert-butoxycarbonyloxyphenyl)propane, 2,2-bis(4-tert-butoxycarbonylmethyloxyphenyl)propane, 2,2-bis(4′-(1″-ethoxyethoxy)phenyl)propane, 2,2-bis(4′-(1″-ethoxypropyloxy)phenyl)propane, tert-butyl 4,4-bis(4′-(2″-tetrahydropyranyloxy)phenyl)valerate, tert-butyl 4,4-bis(4′-(2″-tetrahydrofuranyloxy)phenyl)valerate, tert-butyl 4,4-bis(4′-tert-butoxyphenyl)valerate, tert-butyl 4,4-bis(4-tert-butoxycarbonyloxyphenyl)valerate, tert-butyl 4,4-bis(4′-tert-butoxycarbonylmethyloxyphenyl)-valerate, tert-butyl 4,4-bis(4′-(1″-ethoxyethoxy)phenyl)valerate, tert-butyl 4,4-bis(4′-(1″-ethoxypropyloxy)phenyl)valerate, tris(4-(2′-tetrahydropyranyloxy)phenyl)methane, tris(4-(2′-tetrahydrofuranyloxy)phenyl)methane, tris(4-tert-butoxyphenyl)methane, tris(4-tert-butoxycarbonyloxyphenyl)methane, tris(4-tert-butoxycarbonyloxymethylphenyl)methane, tris(4-(1′-ethoxyethoxy)phenyl)methane, tris(4-(1′-ethoxypropyloxy)phenyl)methane, 1,1,2-tris(4′-(2″-tetrahydropyranyloxy)phenyl)ethane, 1,1,2-tris(4′-(2″-tetrahydrofuranyloxy)phenyl)ethane, 1,1,2-tris(4′-tert-butoxyphenyl)ethane, 1,1,2-tris(4′-tert-butoxycarbonyloxyphenyl)ethane, 1,1,2-tris(4′-tert-butoxycarbonylmethyloxyphenyl)ethane, 1,1,2-tris(4′-(1′-ethoxyethoxy)phenyl)ethane, and 1,1,2-tris(4′-(1′-ethoxypropyloxy)phenyl)ethane.

The basic compound (E) is preferably a compound capable of suppressing the rate of diffusion when the acid generated by the photoacid generator diffuses within the resist film. The inclusion of this type of basic compound holds down the rate of acid diffusion within the resist film, resulting in better resolution. In addition, it suppresses changes in sensitivity following exposure and reduces substrate and environment dependence, as well as improving the exposure latitude and the pattern profile.

Examples of basic compounds include primary, secondary, and tertiary aliphatic amines, mixed amines, aromatic amines, heterocyclic amines, nitrogen-containing compounds having carboxyl group, nitrogen-containing compounds having sulfonyl group, nitrogen-containing compounds having hydroxyl group, nitrogen-containing compounds having hydroxyphenyl group, alcoholic nitrogen-containing compounds, amide derivatives, and imide derivatives.

Examples of suitable primary aliphatic amines include ammonia, methylamine, ethylamine, n-propylamine, isopropylamine, n-butylamine, isobutylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylenediamine, and tetraethylenepentamine. Examples of suitable secondary aliphatic amines include dimethylamine, diethylamine, di-n-propylamine, diisopropylamine, di-n-butylamine, diisobutylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, and N,N-dimethyltetraethylenepentamine. Examples of suitable tertiary aliphatic amines include trimethylamine, triethylamine, tri-n-propylamine, triisopropylamine, tri-n-butylamine, triisobutylamine, tri-sec-butylamine, tripentylamine, tricyclopentylamine, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, and N,N,N′,N′-tetramethyltetraethylenepentamine.

Examples of suitable mixed amines include dimethylethylamine, methylethylpropylamine, benzylamine, phenethylamine, and benzyldimethylamine. Examples of suitable aromatic and heterocyclic amines include aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, diaminonaphthalene, pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isooxazole), thiazole derivatives (e.g., thiazole and isothiazole), imidazole derivatives (e.g., imidazole, 4-methylimidazole, and 4-methyl-2-phenylimidazole), pyrazole derivatives, furazan derivatives, pyrroline derivatives (e.g., pyrroline and 2-methyl-1-pyrroline), pyrrolidine derivatives (e.g., pyrrolidine, N-methylpyrrolidine, pyrrolidinone, and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 1-methyl-2-pyridine, 4-pyrrolidinopyridine, 1-methyl-4-phenylpyridine, 2-(1-ethylpropyl)pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline and 3-quinolinecarbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, guanosine derivatives, uracil derivatives, and uridine derivatives.

Examples of suitable nitrogen-containing compounds having carboxyl group include aminobenzoic acid, indolecarboxylic acid, and amino acid derivatives (e.g. nicotinic acid, alanine, alginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine). Examples of suitable nitrogen-containing compounds having sulfonyl group include 3-pyridinesulfonic acid and pyridinium p-toluenesulfonate. Examples of suitable nitrogen-containing compounds having hydroxyl group, nitrogen-containing compounds having hydroxyphenyl group, and alcoholic nitrogen-containing compounds include 2-hydroxypyridine, aminocresol, 2,4-quinolinediol, 3-indolemethanol hydrate, monoethanolamine, diethanolamine, triethanolamine, N-ethyldiethanolamine, N,N-diethylethanolamine, triisopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]piperazine, piperidine ethanol, 1-(2-hydroxyethyl)pyrrolidine, 1-(2-hydroxyethyl)-2-pyrrolidinone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxyethyl)phthalimide, and N-(2-hydroxyethyl)isonicotinamide. Examples of suitable amide derivatives include formamide, N-methylformamide, N,N-dimethylformamide, acetamide, N-methylacetamide, N,N-dimethylacetamide, propionamide, benzamide, and 1-cyclohexylpyrrolidone. Suitable imide derivatives include phthalimide, succinimide, and maleimide. Suitable carbamate derivatives include N-t-butoxycarbonyl-N,N-dicyclohexylamine, N-t-butoxycarbonylbenzimidazole and oxazolidinone.

In addition, nitrogen-containing compounds of the following general formula (B)-1 may also be included alone or in admixture.
N(X)ₙ(Y)₃₋ₙ (B)-1

In the formula, n is equal to 1, 2 or 3; side chain X, which may be the same or different, is independently selected from groups of the following general formulas (X)-1 to (X)-3, and two or three X's may bond together to form a ring; and side chain Y, which may be the same or different, is independently hydrogen or a straight, branched or cyclic alkyl group of 1 to 20 carbon atoms which may contain a hydroxyl group or ether.

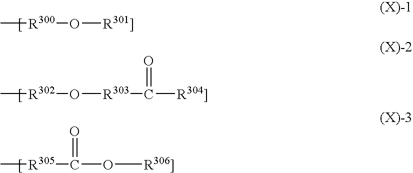

In the formulas, R³⁰⁰, R³⁰² and R³⁰⁵ are independently straight or branched alkylene groups of 1 to 4 carbon atoms; R³⁰¹ and R³⁰⁴ are independently hydrogen, straight, branched or cyclic alkyl groups of 1 to 20 carbon atoms, which may contain at least one hydroxyl group, ether, ester or lactone ring; R³⁰³ is a single bond or a straight or branched alkylene group of 1 to 4 carbon atoms; and R³⁰⁶ is a straight, branched or cyclic alkyl group of 1 to 20 carbon atoms, which may contain at least one hydroxyl group, ether, ester or lactone ring.

Illustrative examples of the compounds of formula (B)-1 include tris(2-methoxymethoxyethyl)amine, tris{2-(2-methoxyethoxy)ethyl}amine, tris{2-(2-methoxyethoxymethoxy)ethyl}amine, tris{2-(1-methoxyethoxy)ethyl}amine, tris{2-(1-ethoxyethoxy)ethyl}amine, tris{2-(1-ethoxypropoxy)ethyl}amine, tris[2-{2-(2-hydroxyethoxy)ethoxy}ethyl]amine, 4,7,13,16,21,24-hexaoxa-1,10-diazabicyclo[8.8.8]hexacosane, 4,7,13,18-tetraoxa-1,10-diazabicyclo[8.5.5]eicosane, 1,4,10,13-tetraoxa-7,16-diazabicyclooctadecane, 1-aza-12-crown-4,1-aza-15-crown-5,1-aza-18-crown-6, tris(2-formyloxyethyl)amine, tris(2-acetoxyethyl)amine, tris(2-propionyloxyethyl)amine, tris(2-butyryloxyethyl)amine, tris(2-isobutyryloxyethyl)amine, tris(2-valeryloxyethyl)amine, tris(2-pivaloyloxyethyl)amine, N,N-bis(2-acetoxyethyl)-2-(acetoxyacetoxy)ethylamine, tris(2-methoxycarbonyloxyethyl)amine, tris(2-tert-butoxycarbonyloxyethyl)amine, tris[2-(2-oxopropoxy)ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyloxy)ethyl]amine, tris(2-methoxycarbonylethyl)amine, tris(2-ethoxycarbonylethyl)amine, N,N-bis(2-hydroxyethyl)-2-(methoxycarbonyl)ethylamine, N,N-bis(2-acetoxyethyl)-2-(methoxycarbonyl)ethylamine, N,N-bis(2-hydroxyethyl)-2-(ethoxycarbonyl)ethylamine, N,N-bis(2-acetoxyethyl)-2-(ethoxycarbonyl)ethylamine, N,N-bis(2-hydroxyethyl)-2-(2-methoxyethoxycarbonyl)ethylamine, N,N-bis(2-acetoxyethyl)-2-(2-methoxyethoxycarbonyl)ethylamine, N,N-bis(2-hydroxyethyl)-2-(2-hydroxyethoxycarbonyl)ethylamine, N,N-bis(2-acetoxyethyl)-2-(2-acetoxyethoxycarbonyl)ethylamine, N,N-bis(2-hydroxyethyl)-2-[(methoxycarbonyl)methoxycarbonyl]-ethylamine, N,N-bis(2-acetoxyethyl)-2-[(methoxycarbonyl)methoxycarbonyl]-ethylamine, N,N-bis(2-hydroxyethyl)-2-(2-oxopropoxycarbonyl)ethylamine, N,N-bis(2-acetoxyethyl)-2-(2-oxopropoxycarbonyl)ethylamine, N,N-bis(2-hydroxyethyl)-2-(tetrahydrofurfuryloxycarbonyl)-ethylamine, N,N-bis(2-acetoxyethyl)-2-(tetrahydrofurfuryloxycarbonyl)-ethylamine, N,N-bis(2-hydroxyethyl)-2-[(2-oxotetrahydrofuran-3-yl)oxy-carbonyl]ethylamine, N,N-bis(2-acetoxyethyl)-2-[(2-oxotetrahydrofuran-3-yl)oxy-carbonyl]ethylamine, N,N-bis(2-hydroxyethyl)-2-(4-hydroxybutoxycarbonyl)ethylamine, N,N-bis(2-formyloxyethyl)-2-(4-formyloxybutoxycarbonyl)-ethylamine, N,N-bis(2-formyloxyethyl)-2-(2-formyloxyethoxycarbonyl)-ethylamine, N,N-bis(2-methoxyethyl)-2-(methoxycarbonyl)ethylamine, N-(2-hydroxyethyl)-bis[2-(methoxycarbonyl)ethyl]amine, N-(2-acetoxyethyl)-bis[2-(methoxycarbonyl)ethyl]amine, N-(2-hydroxyethyl)-bis[2-(ethoxycarbonyl)ethyl]amine, N-(2-acetoxyethyl)-bis[2-(ethoxycarbonyl)ethyl]amine, N-(3-hydroxy-1-propyl)-bis[2-(methoxycarbonyl)ethyl]amine, N-(3-acetoxy-1-propyl)-bis[2-(methoxycarbonyl)ethyl]amine, N-(2-methoxyethyl)-bis[2-(methoxycarbonyl)ethyl]amine, N-butyl-bis[2-(methoxycarbonyl)ethyl]amine, N-butyl-bis[2-(2-methoxyethoxycarbonyl)ethyl]amine, N-methyl-bis(2-acetoxyethyl)amine, N-ethyl-bis(2-acetoxyethyl)amine, N-methyl-bis(2-pivaloyloxyethyl)amine, N-ethyl-bis[2-(methoxycarbonyloxy)ethyl]amine, N-ethyl-bis[2-(tert-butoxycarbonyloxy)ethyl]amine, tris(methoxycarbonylmethyl)amine, tris(ethoxycarbonylmethyl)amine, N-butyl-bis(methoxycarbonylmethyl)amine, N-hexyl-bis(methoxycarbonylmethyl)amine, and β-(diethylamino)-δ-valerolactone.

Also useful are one or more organic nitrogen-containing compounds having cyclic structure represented by the following general formula (B)-2. 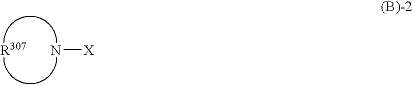
Herein X is as defined above, and R³⁰⁷ is a straight or branched alkylene group of 2 to 20 carbon atoms which may contain one or more carbonyl, ether, ester or sulfide groups.

Illustrative examples of the organic nitrogen-containing compounds having formula (B)-2 include 1-[2-(methoxymethoxy)ethyl]pyrrolidine, 1-[2-(methoxymethoxy)ethyl]piperidine, 4-[2-(methoxymethoxy)ethyl]morpholine, 1-[2-[(2-methoxyethoxy)methoxy]ethyl]pyrrolidine, 1-[2-[(2-methoxyethoxy)methoxy]ethyl]piperidine, 4-[2-[(2-methoxyethoxy)methoxy]ethyl]morpholine, 2-(1-pyrrolidinyl)ethyl acetate, 2-piperidinoethyl acetate, 2-morpholinoethyl acetate, 2-(1-pyrrolidinyl)ethyl formate, 2-piperidinoethyl propionate, 2-morpholinoethyl acetoxyacetate, 2-(1-pyrrolidinyl)ethyl methoxyacetate, 4-[2-(methoxycarbonyloxy)ethyl]morpholine, 1-[2-(t-butoxycarbonyloxy)ethyl]piperidine, 4-[2-(2-methoxyethoxycarbonyloxy)ethyl]morpholine, methyl 3-(1-pyrrolidinyl)propionate, methyl 3-piperidinopropionate, methyl 3-morpholinopropionate, methyl 3-(thiomorpholino)propionate, methyl 2-methyl-3-(1-pyrrolidinyl)propionate, ethyl 3-morpholinopropionate, methoxycarbonylmethyl 3-piperidinopropionate, 2-hydroxyethyl 3-(1-pyrrolidinyl)propionate, 2-acetoxyethyl 3-morpholinopropionate, 2-oxotetrahydrofuran-3-yl 3-(1-pyrrolidinyl)propionate, tetrahydrofurfuryl 3-morpholinopropionate, glycidyl 3-piperidinopropionate, 2-methoxyethyl 3-morpholinopropionate, 2-(2-methoxyethoxy)ethyl 3-(1-pyrrolidinyl)propionate, butyl 3-morpholinopropionate, cyclohexyl 3-piperidinopropionate, α-(1-pyrrolidinyl)methyl-γ-butyrolactone, β-piperidino-γ-butyrolactone, β-morpholino-δ-valerolactone, methyl 1-pyrrolidinylacetate, methyl piperidinoacetate, methyl morpholinoacetate, methyl thiomorpholinoacetate, ethyl 1-pyrrolidinylacetate, and 2-methoxyethyl morpholinoacetate.

Also, one or more organic nitrogen-containing compounds having cyano group represented by the following general formulae (B)-3 to (B)-6 may be blended. 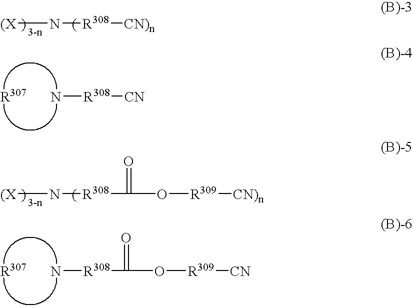
Herein, X, R³⁰⁷ and n are as defined in formula (B)-1, and R³⁰⁸ and R³⁰⁹ are each independently a straight or branched alkylene group of 1 to 4 carbon atoms.

Illustrative examples of the organic nitrogen-containing compounds having cyano represented by formulae (B)-3 to (B)-6 include 3-(diethylamino)propiononitrile, N,N-bis(2-hydroxyethyl)-3-aminopropiononitrile, N,N-bis(2-acetoxyethyl)-3-aminopropiononitrile, N,N-bis(2-formyloxyethyl)-3-aminopropiononitrile, N,N-bis(2-methoxyethyl)-3-aminopropiononitrile, N,N-bis[2-(methoxymethoxy)ethyl]-3-aminopropiononitrile, methyl N-(2-cyanoethyl)-N-(2-methoxyethyl)-3-aminopropionate, methyl N-(2-cyanoethyl)-N-(2-hydroxyethyl)-3-aminopropionate, methyl N-(2-acetoxyethyl)-N-(2-cyanoethyl)-3-aminopropionate, N-(2-cyanoethyl)-N-ethyl-3-aminopropiononitrile, N-(2-cyanoethyl)-N-(2-hydroxyethyl)-3-aminopropiononitrile, N-(2-acetoxyethyl)-N-(2-cyanoethyl)-3-aminopropiononitrile, N-(2-cyanoethyl)-N-(2-formyloxyethyl)-3-aminopropiononitrile, N-(2-cyanoethyl)-N-(2-methoxyethyl)-3-aminopropiononitrile, N-(2-cyanoethyl)-N-[2-(methoxymethoxy)ethyl]-3-aminopropiononitrile, N-(2-cyanoethyl)-N-(3-hydroxy-1-propyl)-3-aminopropiononitrile, N-(3-acetoxy-1-propyl)-N-(2-cyanoethyl)-3-aminopropiononitrile, N-(2-cyanoethyl)-N-(3-formyloxy-1-propyl)-3-aminopropiononitrile, N-(2-cyanoethyl)-N-tetrahydrofurfuryl-3-aminopropiononitrile, N,N-bis(2-cyanoethyl)-3-aminopropiononitrile, diethylaminoacetonitrile, N,N-bis(2-hydroxyethyl)aminoacetonitrile, N,N-bis(2-acetoxyethyl)aminoacetonitrile, N,N-bis(2-formyloxyethyl)aminoacetonitrile, N,N-bis(2-methoxyethyl)aminoacetonitrile, N,N-bis[2-(methoxymethoxy)ethyl]aminoacetonitrile, methyl N-cyanomethyl-N-(2-methoxyethyl)-3-aminopropionate, methyl N-cyanomethyl-N-(2-hydroxyethyl)-3-aminopropionate, methyl N-(2-acetoxyethyl)-N-cyanomethyl-3-aminopropionate, N-cyanomethyl-N-(2-hydroxyethyl)aminoacetonitrile, N-(2-acetoxyethyl)-N-(cyanomethyl)aminoacetonitrile, N-cyanomethyl-N-(2-formyloxyethyl)aminoacetonitrile, N-cyanomethyl-N-(2-methoxyethyl)aminoacetonitrile, N-cyanomethyl-N-[2-(methoxymethoxy)ethyl)aminoacetonitrile, N-cyanomethyl-N-(3-hydroxy-1-propyl)aminoacetonitrile, N-(3-acetoxy-1-propyl)-N-(cyanomethyl)aminoacetonitrile, N-cyanomethyl-N-(3-formyloxy-1-propyl)aminoacetonitrile, N,N-bis(cyanomethyl)aminoacetonitrile, 1-pyrrolidinepropiononitrile, 1-piperidinepropiononitrile, 4-morpholinepropiononitrile, 1-pyrrolidineacetonitrile, 1-piperidineacetonitrile, 4-morpholineacetonitrile, cyanomethyl 3-diethylaminopropionate, cyanomethyl N,N-bis(2-hydroxyethyl)-3-aminopropionate, cyanomethyl N,N-bis(2-acetoxyethyl)-3-aminopropionate, cyanomethyl N,N-bis(2-formyloxyethyl)-3-aminopropionate, cyanomethyl N,N-bis(2-methoxyethyl)-3-aminopropionate, cyanomethyl N,N-bis[2-(methoxymethoxy)ethyl]-3-aminopropionate, 2-cyanoethyl 3-diethylaminopropionate, 2-cyanoethyl N,N-bis(2-hydroxyethyl)-3-aminopropionate, 2-cyanoethyl N,N-bis(2-acetoxyethyl)-3-aminopropionate, 2-cyanoethyl N,N-bis(2-formyloxyethyl)-3-aminopropionate, 2-cyanoethyl N,N-bis(2-methoxyethyl)-3-aminopropionate, 2-cyanoethyl N,N-bis[2-(methoxymethoxy)ethyl]-3-aminopropionate, cyanomethyl 1-pyrrolidinepropionate, cyanomethyl 1-piperidinepropionate, cyanomethyl 4-morpholinepropionate, 2-cyanoethyl 1-pyrrolidinepropionate, 2-cyanoethyl 1-piperidinepropionate, and 2-cyanoethyl 4-morpholinepropionate.

Also included are organic nitrogen-containing compounds having an imidazole structure and a polar functional group, represented by the general formula (B)-7. 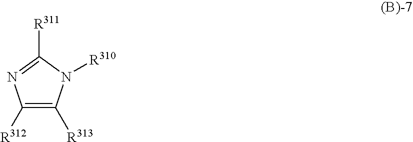
Herein, R³¹⁰ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹¹, R³¹² and R³¹³ are each independently a hydrogen atom, a straight, branched or cyclic alkyl group, aryl group or aralkyl group having 1 to 10 carbon atoms.

Also included are organic nitrogen-containing compounds having a benzimidazole structure and a polar functional group, represented by the general formula (B)-8. 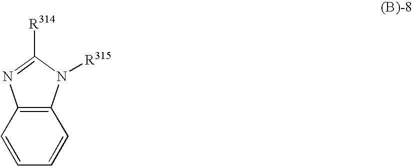
Herein, R³¹⁴ is a hydrogen atom, a straight, branched or cyclic alkyl group, aryl group or aralkyl group having 1 to 10 carbon atoms. R³¹⁵ is a polar functional group-bearing, straight, branched or cyclic alkyl group of 1 to 20 carbon atoms, and the alkyl group contains as the polar functional group at least one group selected from among ester, acetal and cyano groups, and may additionally contain at least one group selected from among hydroxyl, carbonyl, ether, sulfide and carbonate groups.

Further included are heterocyclic nitrogen-containing compounds having a polar functional group, represented by the general formulae (B)-9 and (B)-10. 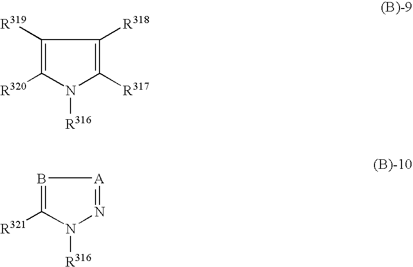
Herein, A is a nitrogen atom or ≡C—R³²², B is a nitrogen atom or ≡C—R³²³, R³¹⁶ is a straight, branched or cyclic alkyl group of 2 to 20 carbon atoms bearing at least one polar functional group selected from among hydroxyl, carbonyl, ester, ether, sulfide, carbonate, cyano and acetal groups; R³¹, R³¹⁸, R³¹⁹ and R³²⁰ are each independently a hydrogen atom, a straight, branched or cyclic alkyl group or aryl group having 1 to 10 carbon atoms, or a pair of R³¹⁷ and R³¹⁸ and a pair of R³¹⁹ and R³²⁰, taken together, may form a benzene, naphthalene or pyridine ring; R³²¹ is a hydrogen atom, a straight, branched or cyclic alkyl group or aryl group having 1 to 10 carbon atoms; R³²² and R³²³ each are a hydrogen atom, a straight, branched or cyclic alkyl group or aryl group having 1 to 10 carbon atoms, or a pair of R³²¹ and R³²³, taken together, may form a benzene or naphthalene ring.

The basic compounds may be used alone or in admixture of two or more. The basic compound is preferably formulated in an amount of 0.001 to 2 parts, and especially 0.01 to 1 part by weight, per 100 parts by weight of the base resin. Less than 0.001 part of the basic compound achieves no or little addition effect whereas more than 2 parts would result in too low a sensitivity.

In addition to the above-described components, the resist composition of the invention may further include any well-known components such as acidic compounds, stabilizers, dyes, and surfactants, if necessary. Such optional components are added in any desired amounts insofar as the benefits of the invention are not impaired.

Of these, surfactants are often used for improving the coating characteristics. Nonionic surfactants are preferred, examples of which include perfluoroalkylpolyoxyethylene ethanols, fluorinated alkyl esters, perfluoroalkylamine oxides, perfluoroalkyl EO-addition products, and fluorinated organosiloxane compounds. Useful surfactants are commercially available under the trade names Fluorad FC-430 and FC-431 from Sumitomo 3M Co., Ltd., Surflon S-141 and S-145, KH-10, KH-20, KH-30 and KH-40 from Asahi Glass Co., Ltd., Unidyne DS-401, DS-403 and DS-451 from Daikin Industry Co., Ltd., Megaface F-8151 from Dainippon Ink & Chemicals, Inc., and X-70-092 and X-70-093 from Shin-Etsu Chemical Co., Ltd. Preferred surfactants are Fluorad FC-430 from Sumitomo 3M Co., Ltd., KH-20, KH-30 from Asahi Glass Co., Ltd., and X-70-093 from Shin-Etsu Chemical Co., Ltd.

In the resist composition, the surfactant is preferably formulated in an amount of up to 2 parts, and especially up to 1 part by weight, per 100 parts by weight of the base resin in the resist composition.

For the microfabrication of integrated circuits, any well-known lithography may be used to form a resist pattern from the chemical amplified positive resist composition of the invention.

The composition is applied onto a substrate (on which an integrated circuit is to be formed, e.g., Si, SiO₂, SiN, SiON, TiN, WSi, BPSG, SOG, organic anti-reflecting film, etc.) by a suitable coating technique such as spin coating, roll coating, flow coating, dip coating, spray coating or doctor coating. The coating is prebaked on a hot plate at a temperature of 60 to 150° C. for about 1 to 10 minutes, preferably 80 to 120° C. for 1 to 5 minutes. The resulting resist film is generally 0.1 to 2.0 μm thick. With a mask having a desired pattern placed above the resist film, the resist film is then exposed to actinic radiation, preferably having an exposure wavelength of up to 300 nm, such as UV, deep-UV, electron beams, x-rays, excimer laser light, γ-rays and synchrotron radiation in an exposure dose of about 1 to 200 mJ/cm², preferably about 10 to 100 mJ/cm². The film is further baked on a hot plate at 60 to 150° C. for 1 to 5 minutes, preferably 80 to 120° C. for 1 to 3 minutes (post-exposure baking=PEB).

Thereafter the resist film is developed with a developer in the form of an aqueous base solution, for example, 0.1 to 5%, preferably 2 to 3% aqueous solution of tetramethylammonium hydroxide (TMAH) for 0.1 to 3 minutes, preferably 0.5 to 2 minutes by conventional techniques such as dipping, puddling or spraying. In this way, a desired resist pattern is formed on the substrate. It is appreciated that the resist composition of the invention is best suited for micro-patterning using such actinic radiation as deep UV with a wavelength of 254 to 193 nm, vacuum UV with a wavelength of 157 nm, electron beams, soft x-rays, x-rays, excimer laser light, γ-rays and synchrotron radiation. With any of the above-described parameters outside the above-described range, the process may sometimes fail to produce the desired pattern.

### EXAMPLE

Examples of the invention are given below by way of illustration and not by way of limitation. Note that Mw and Mn are weight and number average molecular weights, respectively, as measured by GPC relative to polystyrene standards, dispersity is a molecular weight distribution Mw/Mn, and copolymer compositional ratios are on a molar basis.

The organotellurium and organoselenium compounds used are as identified below. 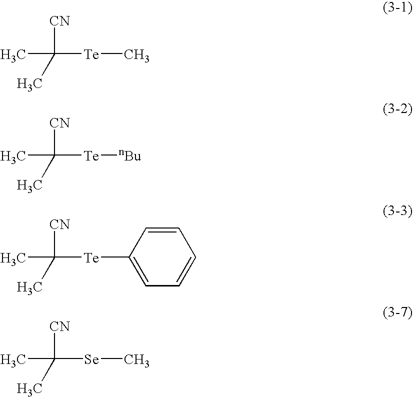
Note that ⁿBu is n-butyl.

### Synthesis Example 1

To a 2-L flask were added 42.7 g of acetoxystyrene, 3.3 g of styrene, 14.0 g of t-butyl methacrylate, and 120 g of tetrahydrofuran (THF) as a solvent. The reactor was cooled to −70° C. in a nitrogen atmosphere, whereupon vacuum deaeration and nitrogen flow were repeated three times. The reactor was warmed up to room temperature, 6.7 g of organotellurium compound (3-2) was added as a polymerization initiator, and the reactor was further heated to 60° C., at which reaction was effected for 15 hours. The reaction solution was concentrated to a one-half volume and poured into a mixture of 4.5 L of methanol and 0.5 L of water for precipitation. The resulting white solids were filtered and vacuum dried at 60° C., obtaining 56 g of a white polymer. The polymer was dissolved again in a mixture of 0.5 L of methanol and 1.0 L of THF, to which were added 70 g of triethylamine and 15 g of water. Deblocking reaction was effected, followed by neutralization with acetic acid. The reaction solution was concentrated and dissolved in 0.5 L of acetone, followed by precipitation, filtration and drying as above. There was obtained 38 g of a white polymer.

The polymer was analyzed by ¹³C-NMR, ¹H-NMR and GPC, with the analytical results shown below.
Copolymer compositional ratio=hydroxystyrene:styrene:t-butyl methacrylate=67.5:7.9:24.6
Mw=10,200
Mw/Mn=1.22

This is designated Polymer A.

Polymers were similarly synthesized using organotellurium compound (3-1) or (3-3) as the polymerization initiator.

Use of Organotellurium Compound (3-1)
Copolymer compositional ratio=hydroxystyrene:styrene:t-butyl methacrylate=67.7:7.8:24.5
Mw=11,000
Mw/Mn=1.20

This is designated Polymer B.

Use of Organotellurium Compound (3-3)
Copolymer compositional ratio=hydroxystyrene:styrene:t-butyl methacrylate=67.2:8.2:24.6
Mw=9,900
Mw/Mn=1.25

This is designated Polymer C.

### Synthesis Example 2

To a 2-L flask were added 41.4 g of acetoxystyrene, 18.9 g of 1-ethylcyclopentyl methacrylate, and 120 g of THF as a solvent. The reactor was cooled to −70° C. in a nitrogen atmosphere, whereupon vacuum deaeration and nitrogen flow were repeated three times. The reactor was warmed up to room temperature, 6.3 g of organotellurium compound (3-2) was added as a polymerization initiator, and the reactor was further heated to 60° C., at which reaction was effected for 15 hours. The reaction solution was concentrated to a one-half volume and poured into a mixture of 4.5 L of methanol and 0.5 L of water for precipitation. The resulting white solids were filtered and vacuum dried at 60° C., obtaining 53 g of a white polymer. The polymer was dissolved again in a mixture of 0.5 L of methanol and 1.0 L of THF, to which were added 70 g of triethylamine and 15 g of water. Deblocking reaction was effected, followed by neutralization with acetic acid. The reaction solution was concentrated and dissolved in 0.5 L of acetone, followed by precipitation, filtration and drying as above. There was obtained 37 g of a white polymer.

The polymer was analyzed by ¹³C-NMR, ¹H-NMR and GPC, with the analytical results shown below.
Copolymer compositional ratio=hydroxystyrene:1-ethylcyclopentyl methacrylate=71.2:28.8
Mw=11,300
Mw/Mn=1.27

This is designated Polymer D.

### Synthesis Example 3

To a 2-L flask were added 41.2 g of acetoxystyrene, 13.0 g of 4-t-butoxystyrene, 5.8 g of t-butyl methacrylate, and 120 g of THF as a solvent. The reactor was cooled to −70° C. in a nitrogen atmosphere, whereupon vacuum deaeration and nitrogen flow were repeated three times. The reactor was warmed up to room temperature, 6.5 g of organotellurium compound (3-2) was added as a polymerization initiator, and the reactor was further heated to 60° C., at which reaction was effected for 15 hours. The reaction solution was concentrated to a one-half volume and poured into a mixture of 4.5 L of methanol and 0.5 L of water for precipitation. The resulting white solids were filtered and vacuum dried at 60° C., obtaining 51 g of a white polymer. The polymer was dissolved again in a mixture of 0.5 L of methanol and 1.0 L of THF, to which were added 70 g of triethylamine and 15 g of water. Deblocking reaction was effected, followed by neutralization with acetic acid. The reaction solution was concentrated and dissolved in 0.5 L of acetone, followed by precipitation, filtration and drying as above. There was obtained 33 g of a white polymer.

The polymer was analyzed by ¹³C-NMR, ¹H-NMR and GPC, with the analytical results shown below.
Copolymer compositional ratio=hydroxystyrene:4-t-butoxystyrene:t-butyl methacrylate=69.0:20.2:10.8
Mw=11,700
Mw/Mn=1.20

This is designated Polymer E.

A polymer was similarly synthesized using 1-ethylcyclopentyl methacrylate instead of t-butyl methacrylate.
Copolymer compositional ratio=hydroxystyrene:4-t-butoxystyrene:1-ethylcyclopentyl methacrylate=72.2:19.9:7.9
Mw=13,100
Mw/Mn=1.31

This is designated Polymer F.

### Synthesis Example 4

To a 2-L flask were added 42.7 g of acetoxystyrene, 3.3 g of styrene, 14.0 g of t-butyl methacrylate, and 120 g of THF as a solvent. The reactor was cooled to −70° C. in a nitrogen atmosphere, whereupon vacuum deaeration and nitrogen flow were repeated three times. The reactor was warmed up to room temperature, 4.5 g of asobisisobutyronitrile (AIBN) and 5.2 g of di-n-butylditelluride were added as a polymerization initiator, and the reactor was further heated to 60° C., at which reaction was effected for 20 hours. The reaction solution was concentrated to a one-half volume and poured into a mixture of 4.5 L of methanol and 0.5 L of water for precipitation. The resulting white solids were filtered and vacuum dried at 60° C., obtaining 50 g of a white polymer. The polymer was dissolved again in a mixture of 0.5 L of methanol and 1.0 L of THF, to which were added 70 g of triethylamine and 15 g of water. Deblocking reaction was effected, followed by neutralization with acetic acid. The reaction solution was concentrated and dissolved in 0.5 L of acetone, followed by precipitation, filtration and drying as above. There was obtained 31 g of a white polymer.

The polymer was analyzed by ¹³C-NMR, ¹H-NMR and GPC, with the analytical results shown below.
Copolymer compositional ratio=hydroxystyrene:styrene:t-butyl methacrylate=67.5:8.2:24.3
Mw=9,700
Mw/Mn=1.35

This is designated Polymer G.

The polymers thus synthesized have the structural formulae below.

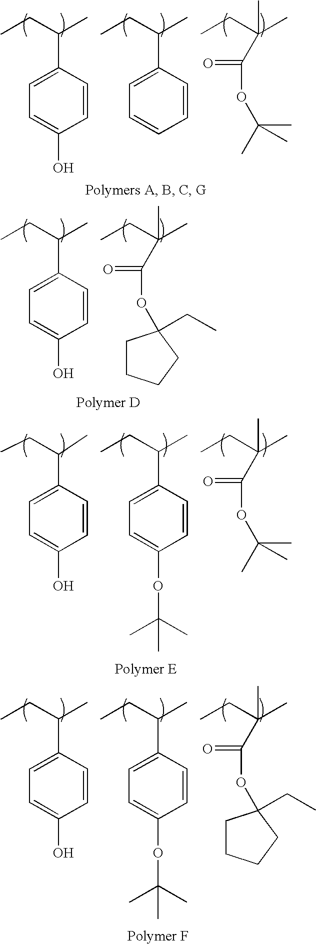

### Comparative Synthesis Example 1

To a 2-L flask were added 42.7 g of acetoxystyrene, 3.3 g of styrene, 14.0 g of t-butyl methacrylate, and 150 g of THF as a solvent. The reactor was cooled to −70° C. in a nitrogen atmosphere, whereupon vacuum deaeration and nitrogen flow were repeated three times. The reactor was warmed up to room temperature, 4.8 g of AIBN was added as a polymerization initiator, and the reactor was further heated to 60° C., at which reaction was effected for 15 hours. The reaction solution was concentrated to a one-half volume and poured into a mixture of 4.5 L of methanol and 0.5 L of water for precipitation. The resulting white solids were filtered and vacuum dried at 60° C., obtaining 43 g of a white polymer. The polymer was dissolved again in a mixture of 0.5 L of methanol and 1.0 L of THF, to which were added 70 g of triethylamine and 15 g of water. Deblocking reaction was effected, followed by neutralization with acetic acid. The reaction solution was concentrated and dissolved in 0.5 L of acetone, followed by precipitation, filtration and drying as above. There was obtained 29 g of a white polymer.

The polymer was analyzed by ¹³C-NMR, ¹H-NMR and GPC, with the analytical results shown below.
Copolymer compositional ratio=hydroxystyrene:styrene:t-butyl methacrylate=67.2:8.5:24.3
Mw=11,900
Mw/Mn=1.89

This is designated Polymer H.

### Comparative Synthesis Example 2

To a 2-L flask were added 41.4 g of acetoxystyrene, 18.9 g of 1-ethylcyclopentyl methacrylate, and 150 g of THF as a solvent. The reactor was cooled to −70° C. in a nitrogen atmosphere, whereupon vacuum deaeration and nitrogen flow were repeated three times. The reactor was warmed up to room temperature, 4.5 g of AIBN was added as a polymerization initiator, and the reactor was further heated to 60° C., at which reaction was effected for 15 hours. The reaction solution was concentrated to a one-half volume and poured into a mixture of 4.5 L of methanol and 0.5 L of water for precipitation. The resulting white solids were filtered and vacuum dried at 60° C., obtaining 46 g of a white polymer. The polymer was dissolved again in a mixture of 0.5 L of methanol and 1.0 L of THF, to which were added 70 g of triethylamine and 15 g of water. Deblocking reaction was effected, followed by neutralization with acetic acid. The reaction solution was concentrated and dissolved in 0.5 L of acetone, followed by precipitation, filtration and drying as above. There was obtained 32 g of a white polymer.

The polymer was analyzed by ¹³C-NMR, ¹H-NMR and GPC, with the analytical results shown below.
Copolymer compositional ratio=hydroxystyrene:1-ethylcyclopentyl methacrylate=71.4:28.6
Mw=12,600
Mw/Mn=1.84

This is designated Polymer I.

### Examples 1 to 6 & Comparative Examples 1 to 2

Chemically amplified positive resist compositions were prepared according to the formulation shown in Tables 1 and 2. The polymers used are Polymers A, B, D to I obtained in Synthesis Examples 1 to 4 and Comparative Synthesis Examples 1 and 2, and the remaining components listed in Tables 1 and 2 have the following meaning.
PAG1: triphenylsulfonium 4-(4′-methylphenylsulfonyloxy)-benzenesulfonate
PAG2: (4-tert-butoxyphenyl)diphenylsulfonium 10-camphorsulfonate
PAG3: bis(cyclohexylsulfonyl)diazomethane
PAG4: bis(2,4-dimethylphenylsulfonyl)diazomethane
Dissolution inhibitor A: bis(4-(2′-tetrahydropyranyloxy)-phenyl)methane
Basic compound A: tris(2-methoxyethyl)amine
Surfactant A: FC-430 (Sumitomo 3M Co., Ltd.)
Surfactant B: Surflon S-381 (Asahi Glass Co., Ltd.)
Solvent A: propylene glycol methyl ether acetate

Solvent B: ethyl lactate

TABLE 1

| Component | Example | | | |
|---|---|---|---|---|
| (pbw) | 1 | 2 | 3 | 4 |
| Polymer A | 80 | — | — | — |
| Polymer B | — | 80 | — | — |
| Polymer D | — | — | 80 | — |
| Polymer E | — | — | — | 80 |
| PAG1 | 2 | 2 | 2 | 1 |
| PAG2 | 1 | 1 | 1 | 1 |
| PAG3 | — | — | — | 0.5 |
| PAG4 | — | — | — | 0.5 |
| Dissolution inhibitor A | — | — | — | — |
| Basic compound A | 0.2 | 0.2 | 0.2 | 0.2 |
| Surfactant A | 0.07 | 0.07 | 0.07 | 0.07 |
| Surfactant B | 0.07 | 0.07 | 0.07 | 0.07 |
| Solvent A | 300 | 300 | 300 | 300 |
| Solvent B | 130 | 130 | 130 | 130 |

TABLE 2

| Component | Example | | Comparative Example | |
|---|---|---|---|---|
| (pbw) | 5 | 6 | 1 | 2 |
| Polymer F | 80 | — | — | — |
| Polymer G | — | 80 | — | — |
| Polymer H | — | — | 80 | — |
| Polymer I | — | — | — | 80 |
| PAG1 | 1 | 2 | 2 | 2 |
| PAG2 | 1 | 1 | 1 | 1 |
| PAG3 | 0.5 | — | — | — |
| PAG4 | 0.5 | — | — | — |
| Dissolution inhibitor A | — | — | — | — |
| Basic compound A | 0.2 | 0.2 | 0.2 | 0.2 |
| Surfactant A | 0.07 | 0.07 | 0.07 | 0.07 |
| Surfactant B | 0.07 | 0.07 | 0.07 | 0.07 |
| Solvent A | 300 | 300 | 300 | 300 |
| Solvent B | 130 | 130 | 130 | 130 |

The resist materials thus obtained were each filtered through a 0.2-μm Teflon® filter, thereby giving resist solutions. These resist solutions were spin-coated onto silicon wafers, then baked on a hot plate at 110° C. for 90 seconds to give resist films having a thickness of 0.6 μm.

The resist films were exposed using an excimer laser stepper NSR2005EX (Nikon Corp., NA 0.5), then baked at 120° C. for 90 seconds (post-exposure baking: PEB), and developed with a solution of 2.38 wt % tetramethylammonium hydroxide (TMAH) in water, thereby giving positive patterns (Examples 1-6 and Comparative Examples 1-2).

The resulting resist patterns were evaluated as described below.

Resist Pattern Evaluation

The exposure dose which provided a 1:1 resolution at the top and bottom of a 0.18-μm line-and-space pattern was the optimum exposure dose (sensitivity Eop). The minimum line width of a line-and-space pattern which was ascertained separate at this dose was the resolution of a test resist. The profile in cross section of the resolved resist pattern was examined under a scanning electron microscope. Line edge roughness on the pattern was observed at the same time. A pattern with less roughness (surface roughness) was rated “good,” a pattern with moderate roughness rated “fair,” and a pattern with much roughness rated “poor.”

The PED stability of a resist was evaluated by effecting post-exposure bake (PEB) after 24 hours of holding from exposure at the optimum dose and determining a variation in line width. The less the variation, the greater is the PED dimensional stability.

The results are shown in Table 3.

TABLE 3

| | | | | Dimensional | | |
|---|---|---|---|---|---|---|
| | | | | stability | | Dispersity |
| | | | | on PED | | (Mw/Mn) |
| | | | | after | Line | of |
| | Sensitivity | Resolution | | 24 hours | edge | polymer |
| | (mJ/cm²) | (μm) | Profile | (nm) | roughness | used |
| Example 1 | 39 | 0.16 | somewhat | −9 | fair | 1.22 |
| | | | tapered | | | |
| Example 2 | 38 | 0.16 | somewhat | −10 | fair | 1.20 |
| | | | tapered | | | |
| Example 3 | 25 | 0.15 | rectangular | −8 | good | 1.27 |
| Example 4 | 29 | 0.16 | rectangular | −10 | good | 1.20 |
| Example 5 | 23 | 0.14 | rectangular | −6 | good | 1.31 |
| Example 6 | 39 | 0.16 | somewhat | −9 | good | 1.35 |
| | | | tapered | | | |
| Comparative | 39 | 0.18 | somewhat | −13 | poor | 1.89 |
| Example 1 | | | tapered | | | |
| Comparative | 25 | 0.17 | rectangular | −10 | poor | 1.84 |
| Example 2 | | | | | | |

### Synthesis Example 5

There were combined 22.2 g of 2-ethyl-2-adamantyl methacrylate, 15.0 g of hydroxyadamantyl methacrylate, 22.8 g of 4,8-dioxatricyclo[4.2.1.0^{3.7}]nonan-5-on-2-yl methacrylate, and 60 g of THF. To this solution, 5.6 g of organotellurium compound (3-2) was added as a polymerization initiator. The reaction solution was stirred for 10 hours while keeping at 80° C. The reaction solution was cooled to room temperature, to which was added 60 g of THF. With vigorous stirring, the reaction solution was added dropwise to 1,200 g of n-hexane. The resulting solids were collected by filtration and vacuum dried at 40° C. for 15 hours, yielding 53 g of a white polymer.

The polymer was analyzed by ¹³C-NMR, ¹H-NMR and GPC, with the analytical results shown below.
Copolymer compositional ratio=2-ethyl-2-adamantyl methacrylate:hydroxyadamantyl methacrylate:4,8-dioxatricyclo[4.2.1.0^{3.7}]nonan-5-on-2-yl methacrylate=34.5:25.0:40.5
Mw=6,800
Mw/Mn=1.45

This is designated Polymer J.

Polymers were similarly synthesized using organoselenium compound (3-7) or a mixture of AIBN and dibutylditelluride as the polymerization initiator.

Use of Organotellurium Compound (3-7)
Copolymer compositional ratio=2-ethyl-2-adamantyl methacrylate:hydroxyadamantyl methacrylate:4,8-dioxatricyclo[4.2.1.0^{3.7}]nonan-5-on-2-yl methacrylate=33.9:26.8:39.3
Mw=6,500
Mw/Mn=1.48

This is designated Polymer K.

Use of AIBN+Dibutylditelluride
Copolymer compositional ratio=2-ethyl-2-adamantyl methacrylate:hydroxyadamantyl methacrylate:4,8-dioxatricyclo[4.2.1.0^{3.7}]nonan-5-on-2-yl methacrylate=34.4:26.9:38.7
Mw=7,000
Mw/Mn=1.40

This is designated Polymer L.

### Synthesis Example 6

There were combined 25.8 g of 2-methyl-2-adamantyl methacrylate, 15.2 g of hydroxyadamantyl methacrylate, 19.0 g of 4,8-dioxatricyclo[4.2.1.0^{3.7}]nonan-5-on-2-yl methacrylate, and 60 g of THF. To this solution, 5.8 g of organotellurium compound (3-2) was added as a polymerization initiator. The reaction solution was stirred for 10 hours while keeping at 80° C. The reaction solution was cooled to room temperature, to which was added 60 g of THF. With vigorous stirring, the reaction solution was added dropwise to 1,200 g of n-hexane. The resulting solids were collected by filtration and vacuum dried at 40° C. for 15 hours, yielding 51 g of a white polymer.

The polymer was analyzed by ¹³C-NMR, ¹H-NMR and GPC, with the analytical results shown below.
Copolymer compositional ratio=2-methyl-2-adamantyl methacrylate:hydroxyadamantyl methacrylate:4,8-dioxatricyclo[4.2.1.0^{3.7}]nonan-5-on-2-yl methacrylate=39.1:26.2:34.7
Mw=7,200
Mw/Mn=1.39

This is designated Polymer M.

The polymers thus synthesized have the structural formulae below.

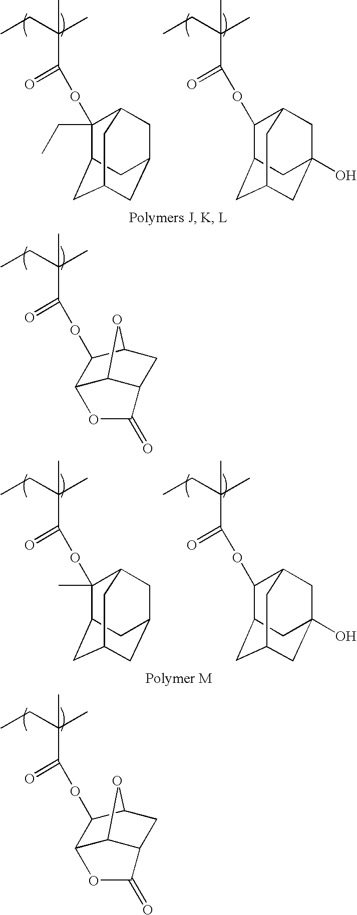

### Comparative Synthesis Example 3

There were combined 22.2 g of 2-ethyl-2-adamantyl methacrylate, 15.0 g of hydroxyadamantyl methacrylate, 22.8 g of 4,8-dioxatricyclo[4.2.1.0^{3.7}]nonan-5-on-2-yl methacrylate, and 120 g of THF. To this solution, 6.0 g of AIBN was added as a polymerization initiator. The reaction solution was stirred for 10 hours while keeping at 80° C. The reaction solution was cooled to room temperature. With vigorous stirring, the reaction solution was added dropwise to 1,200 g of n-hexane. The resulting solids were collected by filtration and vacuum dried at 40° C. for 15 hours, yielding 42 g of a white polymer.

The polymer was analyzed by ¹³C-NMR, ¹H-NMR and GPC, with the analytical results shown below.
Copolymer compositional ratio=2-ethyl-2-adamantyl methacrylate:hydroxyadamantyl methacrylate:4,8-dioxatricyclo[4.2.1.0^{3.7}]nonan-5-on-2-yl methacrylate=34.0:25.8:40.2
Mw=6,500
Mw/Mn=1.92

This is designated Polymer O.

### Comparative Synthesis Example 4

There were combined 25.8 g of 2-methyl-2-adamantyl methacrylate, 15.2 g of hydroxyadamantyl methacrylate, 19.0 g of 4,8-dioxatricyclo[4.2.1.0^{3.7}]nonan-5-on-2-yl methacrylate, and 120 g of THF. To this solution, 6.3 g of AIBN was added as a polymerization initiator. The reaction solution was stirred for 10 hours while keeping at 80° C. The reaction solution was cooled to room temperature. With vigorous stirring, the reaction solution was added dropwise to 1,200 g of n-hexane. The resulting solids were collected by filtration and vacuum dried at 40° C. for 15 hours, yielding 39 g of a white polymer.

The polymer was analyzed by ¹³C-NMR, ¹H-NMR and GPC, with the analytical results shown below.
Copolymer compositional ratio=2-methyl-2-adamantyl methacrylate:hydroxyadamantyl methacrylate:4,8-dioxatricyclo[4.2.1.0^{3.7}]nonan-5-on-2-yl methacrylate=40.2:26.0:33.8
Mw=7,400
Mw/Mn=1.89

This is designated Polymer P.

### Examples 7 to 10 & Comparative Examples 3 to 4

Using each of Polymers J to P obtained in Synthesis Examples 5 and 6 and Comparative Examples 3 and 4, a chemically amplified positive resist material was prepared according to the composition:
(A) 640 parts by weight of propylene glycol monomethyl ether acetate as the solvent,
(B) 80 parts by weight of the polymer (Polymers J to P) as the base resin,
(C) 2.0 parts by weight of triphenylsulfonium nonafluorobutanesulfonate as the acid generator, and
(D) 0.25 part by weight of tris(2-methoxyethyl)amine as the basic compound.
   This was passed through a Teflon® filter having a pore diameter of 0.2 μm.

The resist material was spin coated on a silicon wafer having an antireflective coating (ARC29A by Nissan Chemical Co., Ltd., 78 nm) coated thereon and heat treated at 130° C. for 60 seconds, forming a resist film of 300 nm thick. The resist film was exposed to light in an ArF excimer laser stepper (Nikon Corp., NA=0.68), heat treated (PEB) at 125° C. for 60 seconds, cooled down to 23° C., and puddle developed in a 2.38% aqueous solution of tetramethylammonium hydroxide at 23° C. for 60 seconds, thereby forming a 1:1 line-and-space pattern. The wafer as developed was observed under top-down SEM.

The exposure dose which provided a 1:1 resolution at the top and bottom of a 0.120-μm line-and-space pattern was the optimum exposure dose. The minimum line width of a line-and-space pattern which was ascertained separate at this dose was the resolution of a test resist. The profile in cross section of the resolved resist pattern was examined under a scanning electron microscope. Line edge roughness on the pattern was observed at the same time. A pattern with less roughness (surface roughness) was rated “good,” a pattern with moderate roughness rated “fair,” and a pattern with much roughness rated “poor.”

The results are shown in Table 4.

TABLE 4

| | | Resolution | Line edge | Dispersity |
|---|---|---|---|---|
| | Polymer | (μm) | roughness | (Mw/Mn) |
| Example 7 | J | 0.09 | good | 1.45 |
| Example 8 | K | 0.10 | fair | 1.48 |
| Example 9 | L | 0.08 | good | 1.40 |
| Example 10 | M | 0.10 | fair | 1.39 |
| Comparative | O | 0.11 | poor | 1.92 |
| Example 3 | | | | |
| Comparative | P | 0.12 | poor | 1.89 |
| Example 4 | | | | |

Japanese Patent Application No. 2004-165553 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A polymer for resist use, obtained by radical polymerization of a monomer using an organotellurium or organoselenium compound as a polymerization initiator.

2. The polymer of claim 1, wherein said polymer comprises recurring units having the general formula (1): 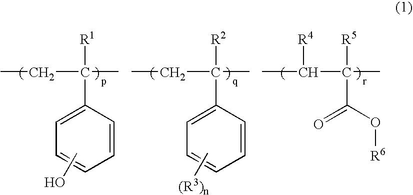
wherein R¹ and R² each are hydrogen or methyl, R³ is a hydrogen atom, straight or branched alkyl group, acid labile group, or halogen atom, R⁴ is hydrogen or methyl, R⁵ is a hydrogen atom, methyl group, trifluoromethyl group, alkoxycarbonyl group, cyano group or halogen atom, R⁶ is a tertiary alkyl group of 4 to 20 carbon atoms, n is 0 or an integer of 1 to 4, p and r are positive numbers, q is 0 or a positive number.

3. The polymer of claim 1, wherein said polymer comprises recurring units having the general formula (2): 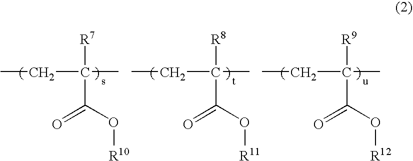
wherein R⁷, R⁸ and R⁹ each are a hydrogen atom, methyl group, trifluoromethyl group, alkoxycarbonyl group, cyano group or halogen atom, R¹⁰ is a tertiary alkyl group of 4 to 30 carbon atoms, R¹¹ is a hydroxyl-containing alkyl group of 2 to 30 carbon atoms, R¹² is a lactone ring-containing alkyl group of 3 to 30 carbon atoms, s is a positive number, t and u each are 0 or a positive number.

4. The polymer of claim 1, having a dispersity of up to 1.5.

5. The polymer of claim 1, wherein the organotellurium or organoselenium compound has the general formula (3): 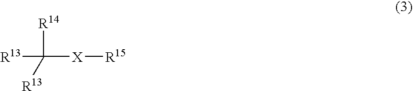
wherein R¹³ is an alkyl group of 1 to 10 carbon atoms, R¹⁴ is a cyano group or alkoxycarbonyl group, R¹⁵ is an alkyl, aryl or alkenyl group of 1 to 30 carbon atoms, and X is Te or Se.

6. The polymer of claim 1, wherein the organotellurium or organoselenium compound has the general formula (4): 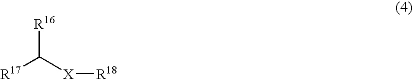
wherein R¹⁶ is hydrogen or methyl, R¹⁷ is an aryl or alkenyl group of 2 to 30 carbon atoms, R¹⁸ is an alkyl, aryl or alkenyl group of 1 to 30 carbon atoms, and X is Te or Se.

7. A method for preparing a polymer for resist use, comprising effecting radical polymerization of a monomer using an organotellurium or organoselenium compound as a polymerization initiator.

8. The method of claim 7, wherein the monomer comprises monomers having the formulae (1a), (1b) and (1c) in amounts of p, q and r moles, respectively, which are subjected to radical polymerization, with the proviso that when R in formula (1a) is a protecting group for hydroxyl, the resulting polymer is deblocked, whereby a polymer comprising recurring units of formula (1) is produced, 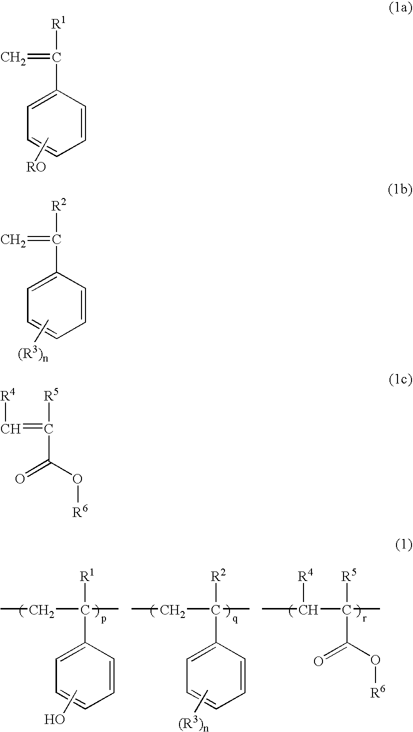
wherein R is hydrogen or a protecting group for hydroxyl, R¹ and R² each are hydrogen or methyl, R³ is a hydrogen atom, straight or branched alkyl group, acid labile group, or halogen atom, R⁴ is hydrogen or methyl, R⁵ is a hydrogen atom, methyl group, trifluoromethyl group, alkoxycarbonyl group, cyano group or halogen atom, R⁶ is a tertiary alkyl group of 4 to 20 carbon atoms, n is 0 or an integer of 1 to 4, p and r are positive numbers, q is 0 or a positive number.

9. The method of claim 7, wherein the monomer comprises monomers having the formulae (2a), (2b) and (2c) in amounts of s, t and u moles, respectively, which are subjected to radical polymerization, whereby a polymer comprising recurring units of formula (2) is produced, 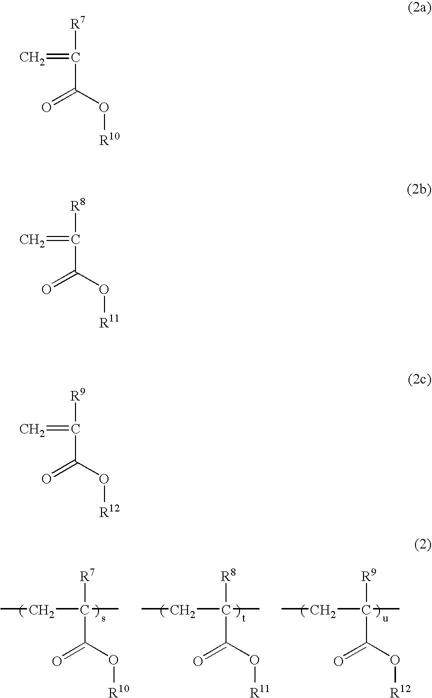
wherein R⁷, R⁸ and R⁹ each are a hydrogen atom, methyl group, trifluoromethyl group, alkoxycarbonyl group, cyano group or halogen atom, R¹⁰ is a tertiary alkyl group of 4 to 30 carbon atoms, R¹¹ is a hydroxyl-containing alkyl group of 2 to 30 carbon atoms, R¹² is a lactone ring-containing alkyl group of 3 to 30 carbon atoms, s is a positive number, t and u each are 0 or a positive number.

10. The method of claim 7, wherein the polymer has a dispersity of up to 1.5.

11. The method of claim 7, wherein the organotellurium or organoselenium compound has the general formula (3): 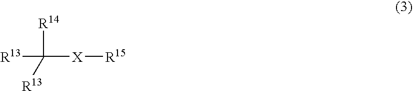
wherein R¹³ is an alkyl group of 1 to 10 carbon atoms, R¹⁴ is a cyano group or alkoxycarbonyl group, R¹⁵ is an alkyl, aryl or alkenyl group of 1 to 30 carbon atoms, and X is Te or Se.

12. The method of claim 7, wherein the organotellurium or organoselenium compound has the general formula (4): 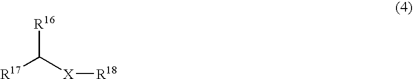
wherein R¹⁶ is hydrogen or methyl, R¹⁷ is an aryl or alkenyl group of 2 to 30 carbon atoms, R¹⁸ is an alkyl, aryl or alkenyl group of 1 to 30 carbon atoms, and X is Te or Se.

13. A chemically amplified positive resist composition comprising:
(A) an organic solvent,
(B) the polymer of claim 1 as a base resin, and
(C) a photoacid generator.

14. A chemically amplified positive resist composition comprising:
(A) an organic solvent,
(B) the polymer of claim 1 as a base resin,
(C) a photoacid generator, and
(D) a dissolution inhibitor.

15. The resist composition of claim 13, further comprising (E) a basic compound.

16. The resist composition of claim 14, further comprising (E) a basic compound.
